(19) United States
(12) Patent Application Publication
(10) Pub. No.: US 2024/0163300 A1
(43) Pub. Date: May 16, 2024

(54) CYBERSECURITY THREAT MITIGATION FOR INDUSTRIAL NETWORKS

(71) Applicant: HONEYWELL INTERNATIONAL INC., Charlotte, NC (US)

(72) Inventors: Punith KUMAR, Bangalore (IN); Atul BASSI, Bangalore (IN); Chetan Siddapura KALLAPPA, Bangalore (IN); Tarun GUPTA, Bangalore (IN)

(21) Appl. No.: 18/055,284

(22) Filed: Nov. 14, 2022

(51) Int. Cl. H04L 9/40

(52) U.S. Cl. CPC H04L 63/1425; H04L 63/1416; H04L 63/205

(57) ABSTRACT

In various embodiments, network traffic data associated with an industrial network is monitored based on a networking event rule set related to defined networking events. The network traffic data is related to a set of asset devices in communication via the industrial network, and the networking event rule set is used to determine a networking event associated with the set of asset devices. A cybersecurity event level for the networking event is determined based on a comparison between a networking event feature set for the networking event and a predefined cybersecurity event feature set for a set of predefined cybersecurity events. In response to a determination that the cybersecurity event level for the networking event satisfies a predefined cybersecurity threat level threshold, a modification is made to one or more configuration parameters for one or more asset devices from the set of asset devices associated with the networking event.

### TECHNICAL FIELD

Embodiments of the present disclosure are generally directed to cybersecurity for industrial networks, and more particularly to management of wireless devices connected to an industrial network to mitigate cybersecurity threats to the industrial network.

### BACKGROUND

Traditional industrial networks associated with industrial environments are becoming increasingly more dynamic, and many assets utilized in industrial networks are capable of being interconnected through various wired networking protocols and/or wireless networking protocols. Additionally, industrial wireless device networks can offer advantages compared to wired device networks. However, the addition of wireless devices and/or wireless field tools in an industrial network can result in insecurities and/or vulnerabilities to a cyberattack.

### SUMMARY

The details of some embodiments of the subject matter described in this specification are set forth in the accompanying drawings and the description below. Other features, aspects, and advantages of the subject matter will become apparent from the description, the drawings, and the claims.

In an embodiment, a system comprises one or more processors, a memory, and one or more programs stored in the memory. The one or more programs comprise instructions configured to monitor, based on a networking event rule set related to defined networking events, network traffic data related to a set of asset devices in communication via an industrial network to determine a networking event associated with the set of asset devices. In response to the networking event, the one or more programs further comprise instructions configured to determine, based on a comparison between a networking event feature set for the networking event and a predefined cybersecurity event feature set for a set of predefined cybersecurity events, a cybersecurity event level for the networking event. In response to a determination that the cybersecurity event level for the networking event satisfies a predefined cybersecurity threat level threshold, the one or more programs further comprise instructions configured to cause a modification to one or more configuration parameters for one or more asset devices from the set of asset devices associated with the networking event.

In another embodiment, a method comprises monitoring, based on a networking event rule set related to defined networking events, network traffic data related to a set of asset devices in communication via an industrial network to determine a networking event associated with the set of asset devices. In response to the networking event, the method also comprises determining, based on a comparison between a networking event feature set for the networking event and a predefined cybersecurity event feature set for a set of predefined cybersecurity events, a cybersecurity event level for the networking event. In response to a determination that the cybersecurity event level for the networking event satisfies a predefined cybersecurity threat level threshold, the method also comprises causing a modification to one or more configuration parameters for one or more asset devices from the set of asset devices associated with the networking event.

In yet another embodiment, a computer program product comprises at least one computer-readable storage medium having program instructions embodied thereon. The program instructions are executable by a processor to cause the processor to monitor, based on a networking event rule set related to defined networking events, network traffic data related to a set of asset devices in communication via an industrial network to determine a networking event associated with the set of asset devices. In response to the networking event, the program instructions further cause the processor to determine, based on a comparison between a networking event feature set for the networking event and a predefined cybersecurity event feature set for a set of predefined cybersecurity events, a cybersecurity event level for the networking event. In response to a determination that the cybersecurity event level for the networking event satisfies a predefined cybersecurity threat level threshold, the program instructions further cause the processor to cause a modification to one or more configuration parameters for one or more asset devices from the set of asset devices associated with the networking event.

### BRIEF DESCRIPTIONS OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein. To easily identify the discussion of any particular element or act, the most significant digit or digits in a reference number refer to the figure number in which that element is first introduced.

FIG. 1 illustrates an exemplary networked computing system environment, in accordance with one or more embodiments described herein.

FIG. 2 illustrates a schematic block diagram of a framework of an IoT platform of the networked computing system, in accordance with one or more embodiments described herein.

FIG. 3 illustrates a system that provides an exemplary environment related to mitigating cybersecurity threats for an industrial network, in accordance with one or more embodiments described herein.

FIG. 4 illustrates an exemplary industrial network cybersecurity system, in accordance with one or more embodiments described herein.

FIG. 5 illustrates an exemplary user computing device system, in accordance with one or more embodiments described herein.

FIG. 6 illustrates an exemplary environment related to collecting network traffic data related to radio frequency signals transmitted by one or more wireless devices communicating in an industrial networking environment, in accordance with one or more embodiments described herein.

FIG. 7 illustrates an exemplary interactive user dashboard, in accordance with one or more embodiments described herein.

FIG. 8 illustrates a process flow diagram for collecting network traffic data in order to classify one or more devices communicating on an industrial network, in accordance with one or more embodiments described herein.

FIG. 9 illustrates a data flow diagram for classifying the status of one or more devices communicating on an industrial network, in accordance with one or more embodiments described herein.

FIG. 10 illustrates a process flow diagram for analyzing historical log data to mitigate cybersecurity threats, in accordance with one or more embodiments described herein.

FIG. 11 illustrates another process flow diagram for analyzing one or more networking events to mitigate cybersecurity threats in accordance with one or more embodiments described herein.

FIG. 12 illustrates a functional block diagram of a computer that may be configured to execute techniques described in accordance with one or more embodiments described herein.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase can be included in at least one embodiment of the present disclosure, and can be included in more than one embodiment of the present disclosure (importantly, such phrases do not necessarily refer to the same embodiment).

The word “exemplary” is used herein to mean “serving as an example, instance, or illustration.” Any implementation described herein as “exemplary” is not necessarily to be construed as preferred or advantageous over other implementations.

If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some embodiments, or it can be excluded.

In general, the present disclosure provides for an “Internet-of-Things” or “IoT” platform for enterprise performance management that uses real-time accurate models and visual analytics to deliver intelligent actionable recommendations for sustained peak performance of an enterprise or organization. The IoT platform is an extensible platform that is portable for deployment in any cloud or data center environment for providing an enterprise-wide, top to bottom view, displaying the status of processes, assets, people, and safety. Further, the IoT platform of the present disclosure supports end-to-end capability to execute digital twins against process data and to translate the output into actionable insights, as detailed in the following description.

Traditional industrial networks associated with industrial environments are becoming increasingly more dynamic, and many assets utilized in industrial networks are capable of being interconnected through various wired networking protocols and/or wireless networking protocols. Additionally, industrial wireless device networks can offer advantages compared to wired device networks. However, the addition of wireless devices and/or wireless field tools in an industrial network can result in insecurities and/or vulnerabilities to a cyberattack. Moreover, traditional techniques for protecting an industrial network from a cyberattack generally lack an adequate protection protocol for the industrial network, especially as industrial networking capacities continue to grow. For example, because of the hybrid networking infrastructures of industrial networks, connecting wireless internet of things (IoT) devices to an industrial network can introduce various types of vulnerabilities to an industrial network. Various access gateways in an industrial network that allow wireless devices and/or wired devices to communicate can also result in various types of vulnerabilities to an industrial network since wireless devices and/or wired devices generally control various portions of an industrial network and/or related industrial infrastructure. These vulnerabilities and/or related cyberattacks can result in a decrease in performance for an industrial network and/or related industrial assets.

To further illustrate issues related to traditional industrial networks, it is generally difficult to manage newly added IoT devices in an industrial network to mitigate vulnerabilities and/or cyberattacks. For example, industrial asset inventory tools and/or industrial asset discovery tools typically only discover assets which are connected via a wired network and fail to detect other devices which are connected to the industrial network through various wireless protocols. With traditional monitoring techniques for industrial networks, it is also generally difficult to determine detect and/or classify a new wireless device for the industrial network. Accordingly, undetected and/or unclassified wireless IoT devices connected to an industrial network can be susceptible to cyberattacks. To make matters more difficult, network traffic for an industrial network is often encrypted for security purposes, but this can compound problems related to identifying unknown devices communicating on an industrial network. Additionally, in many cases, an industrial automation and control system does not have detailed knowledge of the available IoT devices on an industrial network, and an attacker could exploit this lack of knowledge to perform a cyberattack.

Such cyberattacks can include an interruption of an industrial processes, an attack with respect to functionality of control systems associated with the industrial processes, installation of malicious software, and/or introduction of a “backdoor” in which the attacker can collect data from other systems related to the industrial network. It is therefore desirable to identify trusted and untrusted devices on an industrial network to ensure industrial network security and/or to mitigate any potential cybersecurity threats to the industrial network. However, given the size and scope of typical industrial networks, it is generally difficult to identify a potential cybersecurity threat and/or to take action to mitigate a potential cybersecurity threat. In an industrial network, wireless-capable assets are often operation-critical, and there is often difficult to mitigate a detected cybersecurity threats associated with those wireless-capable assets without negatively impacting performance of the industrial network and/or industrial assets. Furthermore, excessive computing resources are often employed by a system to identify particular devices associated with a cybersecurity threat, to perform a root-cause analysis of a cybersecurity threat, to take actions to mitigate the cybersecurity threat related to those particular devices. Currently, resolving these issues is often a manual mitigation process that a user performs, and often times the cyberattack has already occurred and/or damage to an industrial system is already done before a user becomes aware of a cybersecurity threat.

Thus, to address these and other problems, various embodiments of the present disclosure relate to systems, apparatuses, computer-implemented methods, and computer program products that provide cybersecurity threat mitigation for industrial networks. In various embodiments, industrial network traffic can be monitored and/or analyzed to identify and mitigate cybersecurity threats and/or vulnerabilities created through the integration of wireless IoT devices in an industrial network. In various embodiments, one or more node detection techniques can be employed on an industrial network such that the industrial network can be repeatedly monitored. Any new asset devices being added to the industrial network can also be identified and/or classified based on the respective asset device type and/or how the new asset devices are connected to the industrial network. Furthermore, as the asset devices and/or network traffic of the industrial network are repeatedly monitored, any modifications made to the configurations of existing asset devices in the industrial network can be logged and/or stored in a database. One or more notifications for rendering via an electronic interface can also be generated based on any modifications made to the configurations.

In one or more embodiments, an industrial network cybersecurity system is employed in a level-three (L3) industrial network layer. The L3 industrial network layer can be a process and control layer of a four-layer industrial networking topology. In one or more embodiments, an industrial network cybersecurity system can be integrated into the L3 industrial network layer to monitor communication between wireless networking devices and/or wired networking devices. The L3 industrial network layer can also be configured to manage wireless devices interfacing with the industrial network through various access gateways. Various embodiments of the present disclosure can interface with various access gateways in the L3 network in order to collect network traffic data from the industrial network that is initiated by wired devices and/or wireless asset devices communicating on the industrial network and analyze said network traffic data to determine whether any adverse networking events are occurring.

In various embodiments, an industrial network cybersecurity system repeatedly monitors an industrial network and collects network traffic data associated with one or more devices communicating on the industrial network and stores the network traffic data in a repository. The network traffic data can comprise metadata related to each device including, but not limited to, the type of device (wired or wireless), the model and/or vendor of the device, address information (e.g., IP and/or MAC address data), networking protocols, data transmission timestamp information, and/or various configuration parameters associated with the device. The network traffic data is then processed and standardized into one or more respective networking events. The one or more networking events can be electronically managed data objects comprising the metadata related to the devices and organized into a structured format. Once properly formatted, the network traffic data comprising the one or more networking events can be analyzed and compared to baseline asset data related to the industrial network as well as a networking event rule set related to defined networking events.

In one or more embodiments, an industrial network data repository system comprising one or more asset device databases contains baseline asset data related to the trusted devices that have been approved to communicate on the industrial network. In various embodiments, the baseline asset data comprises one or more asset device instances. The one or more asset device instances can be electronically managed data objects containing structured metadata related to the trusted devices in the industrial network. In one or more embodiments, the one or more asset device instances comprise metadata related to, but not limited by, asset device identifiers, MAC addresses, IP addresses, hostnames, vendor names, operating system identifiers, data related to networking protocols being employed by the asset devices (e.g., TCP and/or UDP), device status (e.g., “pending,” or “under investigation”), as well as historical log data such as timestamp data, identifiers corresponding to various networking devices (e.g., networking switch and/or router addresses) used by the asset device during transmission, port numbers used, and/or other descriptions. The one or more asset device instances in the baseline asset data also comprise various configuration parameters related to the respective asset devices associated with the industrial network that dictate various operating configurations associated with each respective asset device that has been approved to communicate on the industrial network. In various embodiments, the industrial network cybersecurity system automatically generates asset device instances for any new unknown device communicating on the industrial network and stores the asset device instances in the industrial network data repository system to facilitate analysis.

Comparisons can be made between network traffic data that has been formatted and the baseline asset data comprised in the industrial network data repository system to identify if any new devices have been connected to the industrial network, identify whether any modifications to the configuration parameters associated with any respective approved devices have been made, and/or detect any unusual and/or malicious activity performed by any devices communicating on the industrial network. Results of these comparisons can be transmitted to a user device in various ways including, but not limited to, alerts, notifications, alarm triggers, generated networking event reports, and more. Additionally, any comparison result data generated while comparing the network traffic data and the baseline asset data associated with the industrial network can also be rendered on the interactive user dashboard in accordance with various embodiments of the present disclosure.

In one or more embodiments, each one of an identification of a new asset device, an identification of a modification in configuration parameters associated with a known asset device, and/or a detection of suspicious activity being performed by an asset device on the industrial network can be compiled into a respective networking event. The networking event can be an electronically managed data object comprising a networking event feature set corresponding to any metadata related to the associated asset devices and any information related to the networking event itself. Data related to such networking events can be transmitted to a user device and be rendered, among other information, on an interactive user dashboard on a computing device system associated with the industrial network. In various embodiments, a networking event comprises metadata related to a networking event type, an asset device identifier, an asset device address, a cybersecurity event level, a networking event description, networking event timestamp information, a networking event status, and/or a responsible administrator identifier. In one or more embodiments, the industrial network cybersecurity system can store and/or update the industrial network data repository system with any data related to the network traffic data, data related to any of the one or more asset device instances associated with the devices communicating on the industrial network, historical log data associated the asset devices communicating on the industrial network, and/or any data related to the one or more networking events taking place on the industrial network.

In various embodiments, the types of networking events can be related to, but are not limited by, detected signal strength data associated with an asset device communicating on the industrial network, a type of wireless protocol, a beacon event, a probing event, an authentication event, a data frame event, a network address sharing event, detected radio frequency signals collected from the airspace of the industrial environment associated with the industrial network, and/or another type of networking event. The types of networking events can additionally or alternatively be related to suspicious activity related to, but not limited by, unauthorized access where an unknown user is trying to access one or more asset devices, unusual activity performed by a user after gaining access to the one or more asset devices, anomalies in inbound and outbound industrial network traffic, detection of an untrusted device in the network, threats from internal users known as “insider threats,” as well as malicious activity related to know types of malware. In various embodiments, said types of suspicious activity can correspond to a predefined cybersecurity event feature set corresponding to a respective, predefined cybersecurity event of a set of predefined cybersecurity events stored in the industrial network data repository system.

As networking events occur, the networking events can be classified by the industrial network cybersecurity system and/or related data can be stored in the industrial network data repository system to facilitate analysis. Additionally, as networking events occur, various notifications and/or alarms can be triggered based on the classifications associated with the networking events. For example, if a networking event has a cybersecurity event level of “high” or “critical,” various notifications and alerts can be rendered on the interactive user dashboard generated by the industrial network cybersecurity system to prompt expedited action with respect to the cybersecurity event. In various embodiments, the industrial network cybersecurity system can also transmit notifications and alerts associated with networking events to one or more user devices such that no cybersecurity threat goes unacknowledged. In one or more embodiments, the industrial network cybersecurity system can also execute automatic cybersecurity threat mitigation actions to mitigate cybersecurity threats as the cybersecurity threats are detected. Such cybersecurity threat mitigation techniques can stop a cybersecurity threat quickly without the need for user intervention, thus mitigating the cybersecurity threat and/or improving performance of an industrial network.

For example, if the industrial network cybersecurity system detects a networking event with an associated cybersecurity threat level such as “critical” (such as unusual activity on the industrial network from an asset device with privileged user access permissions), the industrial network cybersecurity system can temporarily decommission the associated asset device such that the associated asset device can make no further communications on the industrial network until a user can review the networking event. Likewise, if the industrial network cybersecurity system detects a networking event with a cybersecurity event level classification of “high” (such as unauthorized insiders continually attempting to access part of the industrial network (e.g., the industrial network data repository system) from a particular asset device), the industrial network cybersecurity system can automatically decommission the asset device, flag the user account in question, and/or transmit an alert to a user device with the details of the networking event.

In one or more embodiments, decommissioning an asset device can include at least one of, but is not limited to, de-powering or putting the device into a stand-by mode, modifying one or more configuration parameters associated with the asset device, changing user access permissions associated with the asset device, storing identifying information associated with the device on a “blacklist” in the industrial network data repository system (e.g., MAC addresses, IP addresses, and/or any other metadata associated with the asset device), and/or otherwise ensuring the asset device can no longer communicate on the industrial network.

In various embodiments, the industrial network cybersecurity system can employ one or more node detection techniques to classify devices communicating on the industrial network as trusted or untrusted devices based on the information rendered on the interactive user dashboard. In one or more embodiments, when a new node, or device, is connected to the industrial network, the industrial network cybersecurity system automatically creates an asset device instance associated with the new device and updates the metadata related to the status of the new device in the asset device instance as “pending.” Some cyberattacks involve duplicating legitimate devices, so, in one or more embodiments, one or more new devices communicating on the industrial network are updated with a status of “pending” to facilitate review of the new device and/or to approve or deny the new device access to the industrial network. In some embodiments, a list of all asset devices communicating on the industrial network can be presented on the interactive user dashboard and filtered by the respective statuses of the asset devices. In various embodiments, an asset device communicating on the industrial network can be assigned a status including, but not limited to, “pending,” “approved,” “under investigation,” and/or “removed.” In one or more embodiments, a new, unknown device communicating on the industrial network can be authenticated via the interactive user dashboard and update the metadata in a corresponding asset device instance associated with the device in industrial network data repository system. As such, when a new device has been approved and/or employed on the industrial network, the baseline asset data associated with the industrial network can be updated to include the asset device instance and metadata associated with the newly trusted device.

In some embodiments, a mapping of network switches and/or network ports can be generated based on the one or more approved asset devices associated with the industrial network. One or more nodes associated with respective approved asset devices can be generated. The one or more nodes can be an electronically managed data object comprising metadata associated with a respective asset device. In various embodiments, the metadata comprised in the one or more nodes can be related to, but is not limited by, node identifiers, asset device identifiers, MAC addresses, IP addresses, hostnames, vendor names, operating system identifiers, data related to networking protocols being employed by the asset devices (e.g., TCP and/or UDP), device status (e.g., “pending,” or “under investigation”), as well as historical log data such as timestamp data, identifiers corresponding to various networking devices (e.g., networking switch and/or router addresses) used by the asset device during transmission, port numbers used, and/or other descriptions.

In various embodiments, the mapping of network switches and/or network ports can be a configuration of visually interconnected interactive display elements associated with the one or more nodes and rendered on the interactive user dashboard. Additionally and/or alternatively, the mapping of network switches and/or network ports can be configured as a list of interactive display elements describing the one or more nodes and rendered on the interactive user dashboard. In various embodiments, when a node associated with an approved asset device is generated, the node is automatically added to the mapping of network switches and/or network ports and metadata associated with the node is updated and stored in the industrial network data repository system. Likewise, in various embodiments, when a newly approved asset device communicating on the industrial network is authenticated, a node associated with the newly approved asset device is generated and the mapping of network switches and/or network ports is automatically updated to include the node.

Additionally and/or alternatively, the industrial network cybersecurity system can compare unknown devices communicating on the industrial network to an asset device whitelist associated with an industrial enterprise related to the industrial network. The industrial enterprise may distribute the asset device whitelist to a user device to facilitate monitoring respective industrial networks at various industrial networks so that field workers operating whitelisted IoT devices in multiple industrial networks won't trigger any alarms when connecting the whitelisted IoT devices to a particular industrial network. If an unknown device communicating on the industrial network is identified as a whitelisted device, the industrial network cybersecurity system can automatically approve the unknown device to communicate on the industrial network and update the baseline asset data in the asset device sever system with metadata associated with the unknown device.

In one or more embodiments, the industrial network cybersecurity system automatically classifies the status of unknown devices communicating on the industrial network as “pending,” and updates metadata related to the status of the unknown device in an asset device instance associated with the unknown device. Various statuses can be attributed to the one or more devices communicating on the industrial network including, but not limited to, “pending,” “approved,” “under investigation,” and “removed” by updating the metadata of a respective asset device instance corresponding to the one or more devices. In various embodiments, the status of any device communicating on the industrial network can be updated via the interactive user dashboard generated by the industrial network cybersecurity system, thereby determining which devices are allowed to communicate on the industrial network. In one or more embodiments, any time an update is made to an asset device instance associated with an industrial asset, the baseline asset data associated with the industrial network is automatically updated as well.

In one or more embodiments, the industrial network cybersecurity system can generate an interactive user dashboard and render any data related to the network traffic data being collected from the industrial network in real time. Additionally, the industrial network cybersecurity system can render data related to the baseline asset data, the number of devices communicating on the industrial network, the ratio of trusted to untrusted devices, graphs representing networking event frequencies, and/or tables detailing the one or more networking events occurring in the industrial network on the interactive user dashboard. In one or more embodiments, networking event reports and summaries can be generated based on the data being rendered on the interactive user dashboard and can be exported from the industrial network cybersecurity system. In various embodiments, the one or more networking event reports and summaries can be automatically generated based on a predefined schedule (e.g., daily, weekly, bi-weekly, monthly, etc.) and transmitted to one or more user devices.

As such, by employing one or more techniques disclosed herein, various technical improvements can be achieved. Embodiments of the present disclosure can reduce the vulnerabilities of an industrial network and/or can improve the manageability of such industrial networks. Additionally, embodiments of the present disclosure can also streamline resources necessary to successfully secure an industrial network from cyber threats. For instance, the automatic cybersecurity threat mitigation actions executed by an industrial network cybersecurity system can reduce computing resources by automatically decommissioning asset devices that are threatening the industrial network until the networking event can be reviewed. These technical improvements make the industrial network more robust against cyberattacks and can stop an attack before critical industrial infrastructure can be breached. Furthermore, embodiments of the present disclosure can sustain and/or improve upon industrial cybersecurity standards, as well as make compliance with cybersecurity standards easier to employ across every industrial network associated with a particular industrial enterprise.

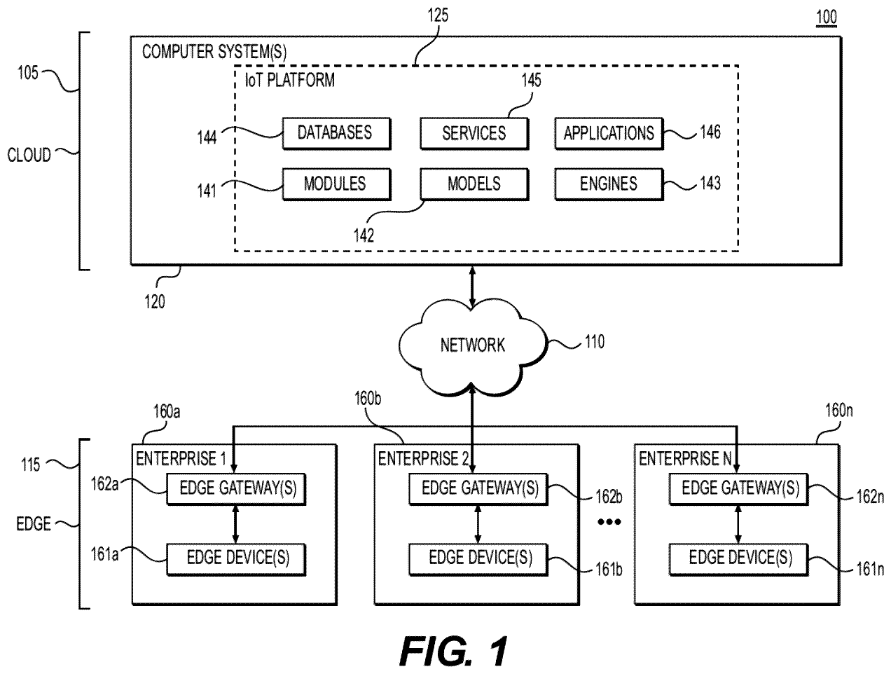

FIG. 1 illustrates an exemplary networked computing system environment 100, according to the present disclosure. As shown in FIG. 1, networked computing system environment 100 is organized into a plurality of layers including a cloud 105 (e.g., cloud layer 105), a network 110 (e.g., a network layer 110), and an edge 115 (e.g., edge layer 115). As detailed further below, components of the edge 115 are in communication with components of the cloud 105 via network 110.

In various embodiments, network 110 is any suitable network or combination of networks and supports any appropriate protocol suitable for communication of data to and from components of the cloud 105 and between various other components in the networked computing system environment 100 (e.g., components of the edge 115). According to various embodiments, network 110 includes a public network (e.g., the Internet), a private network (e.g., a network within an organization), or a combination of public and/or private networks. According to various embodiments, network 110 is configured to provide communication between various components depicted in FIG. 1. According to various embodiments, network 110 comprises one or more networks that connect devices and/or components in the network layout to allow communication between the devices and/or components. For example, in one or more embodiments, the network 110 is implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. In some embodiments, network 110 is implemented using cellular networks, satellite, licensed radio, or a combination of cellular, satellite, licensed radio, and/or unlicensed radio networks.

Components of the cloud 105 include one or more computer systems 120 that form a so-called “Internet-of-Things” or “IoT” platform 125. It should be appreciated that “IoT platform” is an optional term describing a platform connecting any type of Internet-connected device, and should not be construed as limiting on the types of computing systems useable within IoT platform 125. In particular, in various embodiments, computer systems 120 includes any type or quantity of one or more processors and one or more data storage devices comprising memory for storing and executing applications or software modules of networked computing system environment 100. In one embodiment, the processors and data storage devices are embodied in server-class hardware, such as enterprise-level servers. For example, in an embodiment, the processors and data storage devices comprise any type or combination of application servers, communication servers, web servers, super-computing servers, database servers, file servers, mail servers, proxy servers, and/virtual servers. Further, the one or more processors are configured to access the memory and execute processor-readable instructions, which when executed by the processors configures the processors to perform a plurality of functions of the networked computing system environment 100. In certain embodiments, the networked computing system environment 100 is an on-premise networked computing system where the edge 115 is configured as a process control network and the cloud 105 is configured as an enterprise network.

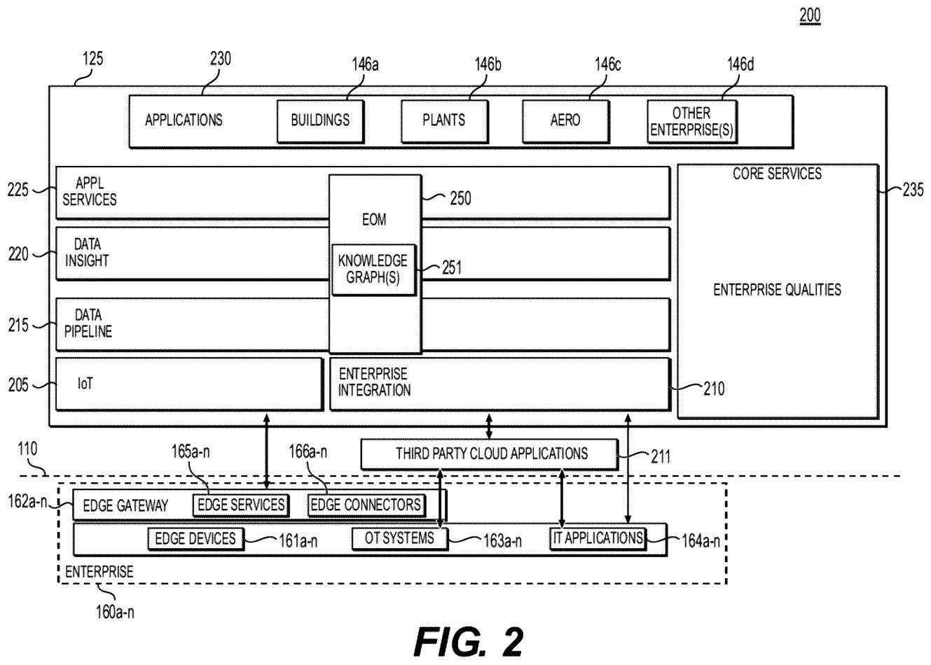

Computer systems 120 further include one or more software components of the IoT platform 125. For example, in one or more embodiments, the software components of computer systems 120 include one or more software modules to communicate with user devices and/or other computing devices through network 110. For example, in one or more embodiments, the software components include one or more modules 141, models 142, engines 143, databases 144, services 145, and/or applications 146, which may be stored in/by the computer systems 120 (e.g., stored on the memory), as detailed with respect to FIG. 2 below. According to various embodiments, the one or more processors are configured to utilize the one or more modules 141, models 142, engines 143, databases 144, services 145, and/or applications 146 when performing various methods described in this disclosure.

Accordingly, in one or more embodiments, computer systems 120 execute a cloud computing platform (e.g., IoT platform 125) with scalable resources for computation and/or data storage, and may run one or more applications on the cloud computing platform to perform various computer-implemented methods described in this disclosure. In some embodiments, some of the modules 141, models 142, engines 143, databases 144, services 145, and/or applications 146 are combined to form fewer modules, models, engines, databases, services, and/or applications. In some embodiments, some of the modules 141, models 142, engines 143, databases 144, services 145, and/or applications 146 are separated into separate, more numerous modules, models, engines, databases, services, and/or applications. In some embodiments, some of the modules 141, models 142, engines 143, databases 144, services 145, and/or applications 146 are removed while others are added.

The computer systems 120 are configured to receive data from other components (e.g., components of the edge 115) of networked computing system environment 100 via network 110. Computer systems 120 are further configured to utilize the received data to produce a result. According to various embodiments, information indicating the result is transmitted to users via user computing devices over network 110. In some embodiments, the computer systems 120 is a server system that provides one or more services including providing the information indicating the received data and/or the result(s) to the users. According to various embodiments, computer systems 120 are part of an entity which include any type of company, organization, or institution that implements one or more IoT services. In some examples, the entity is an IoT platform provider.

Components of the edge 115 include one or more enterprises 160a-160n each including one or more edge devices 161a-161n and one or more edge gateways 162a-162n. For example, a first enterprise 160a includes first edge devices 161a and first edge gateways 162a, a second enterprise 160b includes second edge devices 161b and second edge gateways 162b, and an nth enterprise 160n includes nth edge devices 161n and nth edge gateways 162n. As used herein, enterprises 160a-160n represent any type of entity, facility, or vehicle, such as, for example, companies, divisions, buildings, manufacturing plants, warehouses, real estate facilities, laboratories, aircraft, spacecraft, automobiles, ships, boats, military vehicles, oil and gas facilities, or any other type of entity, facility, and/or entity that includes any number of local devices.

According to various embodiments, the edge devices 161a-161n represent any of a variety of different types of devices that may be found within the enterprises 160a-160n. Edge devices 161a-161n are any type of device configured to access network 110, or be accessed by other devices through network 110, such as via an edge gateway 162a-162n. According to various embodiments, edge devices 161a-161n are “IoT devices” which include any type of network-connected (e.g., Internet-connected) device. For example, in one or more embodiments, the edge devices 161a-161n include assets, sensors, actuators, processors, computers, valves, pumps, ducts, vehicle components, cameras, displays, doors, windows, security components, boilers, chillers, pumps, air handler units, HVAC components, factory equipment, and/or any other devices that are connected to the network 110 for collecting, sending, and/or receiving information. Each edge device 161a-161n includes, or is otherwise in communication with, one or more controllers for selectively controlling a respective edge device 161a-161n and/or for sending/receiving information between the edge devices 161a-161n and the cloud 105 via network 110. With reference to FIG. 2, in one or more embodiments, the edge 115 include operational technology (OT) systems 163a-163n and information technology (IT) applications 164a-164n of each enterprise 160a-160n. The OT systems 163a-163n include hardware and software for detecting and/or causing a change, through the direct monitoring and/or control of industrial equipment (e.g., edge devices 161a-161n), assets, processes, and/or events. The IT applications 164a-164n includes network, storage, and computing resources for the generation, management, storage, and delivery of data throughout and between organizations.

The edge gateways 162a-162n include devices for facilitating communication between the edge devices 161a-161n and the cloud 105 via network 110. For example, the edge gateways 162a-162n include one or more communication interfaces for communicating with the edge devices 161a-161n and for communicating with the cloud 105 via network 110. According to various embodiments, the communication interfaces of the edge gateways 162a-162n include one or more cellular radios, Bluetooth, WiFi, near-field communication radios, Ethernet, or other appropriate communication devices for transmitting and receiving information. According to various embodiments, multiple communication interfaces are included in each gateway 162a-162n for providing multiple forms of communication between the edge devices 161a-161n, the gateways 162a-162n, and the cloud 105 via network 110. For example, in one or more embodiments, communication is achieved with the edge devices 161a-161n and/or the network 110 through wireless communication (e.g., WiFi, radio communication, etc.) and/or a wired data connection (e.g., a universal serial bus, an onboard diagnostic system, etc.) or other communication modes, such as a local area network (LAN), wide area network (WAN) such as the Internet, a telecommunications network, a data network, or any other type of network.

According to various embodiments, the edge gateways 162a-162n also include a processor and memory for storing and executing program instructions to facilitate data processing. For example, in one or more embodiments, the edge gateways 162a-162n are configured to receive data from the edge devices 161a-161n and process the data prior to sending the data to the cloud 105. Accordingly, in one or more embodiments, the edge gateways 162a-162n include one or more software modules or components for providing data processing services and/or other services or methods of the present disclosure. With reference to FIG. 2, each edge gateway 162a-162n includes edge services 165a-165n and edge connectors 166a-166n. According to various embodiments, the edge services 165a-165n include hardware and software components for processing the data from the edge devices 161a-161n. According to various embodiments, the edge connectors 166a-166n include hardware and software components for facilitating communication between the edge gateway 162a-162n and the cloud 105 via network 110, as detailed above. In some cases, any of edge devices 161a-n, edge connectors 166a-n, and edge gateways 162a-n have their functionality combined, omitted, or separated into any combination of devices. In other words, an edge device and the edge device's connector and gateway need not necessarily be discrete devices.

FIG. 2 illustrates a schematic block diagram of framework 200 of the IoT platform 125, according to the present disclosure. The IoT platform 125 of the present disclosure is a platform for enterprise performance management that uses real-time accurate models and visual analytics to deliver intelligent actionable recommendations and/or analytics for sustained peak performance of the enterprise 160a-160n. The IoT platform 125 is an extensible platform that is portable for deployment in any cloud or data center environment for providing an enterprise-wide, top to bottom view, displaying the status of processes, assets, people, and safety. Further, the IoT platform 125 supports end-to-end capability to execute digital twins against process data and to translate the output into actionable insights, using the framework 200, detailed further below.

As shown in FIG. 2, the framework 200 of the IoT platform 125 comprises a number of layers including, for example, an IoT layer 205, an enterprise integration layer 210, a data pipeline layer 215, a data insight layer 220, an application services layer 225, and an applications layer 230. The IoT platform 125 also includes a core services layer 235 and an extensible object model (EOM) 250 comprising one or more knowledge graphs 251. The layers 205-235 further include various software components that together form each layer 205-235. For example, in one or more embodiments, each layer 205-235 includes one or more of the modules 141, models 142, engines 143, databases 144, services 145, applications 146, or combinations thereof. In some embodiments, the layers 205-235 are combined to form fewer layers. In some embodiments, some of the layers 205-235 are separated into separate, more numerous layers. In some embodiments, some of the layers 205-235 are removed while others may be added. In certain embodiments, the framework 200 can be an on-premise framework where the edge devices 161a-161n are configured as part of a process control network and the IoT platform 125 is configured as an enterprise network.

The IoT platform 125 is a model-driven architecture. Thus, the extensible object model 250 communicates with each layer 205-230 to contextualize site data of the enterprise 160a-160n using an extensible graph-based object model (or “asset model”). In one or more embodiments, the extensible object model 250 is associated with knowledge graphs 251 where the equipment (e.g., edge devices 161a-161n) and processes of the enterprise 160a-160n are modeled. The knowledge graphs 251 of EOM 250 are configured to store the models in a central location. The knowledge graphs 251 define a collection of nodes and links that describe real-world connections that enable smart systems. As used herein, a knowledge graph 251: (i) describes real-world entities (e.g., edge devices 161a-161n) and their interrelations organized in a graphical interface; (ii) defines possible classes and relations of entities in a schema; (iii) enables interrelating arbitrary entities with each other; and (iv) covers various topical domains. In other words, the knowledge graphs 251 define large networks of entities (e.g., edge devices 161a-161n), semantic types of the entities, properties of the entities, and relationships between the entities. Thus, the knowledge graphs 251 describe a network of “things” that are relevant to a specific domain or to an enterprise or organization. Knowledge graphs 251 are not limited to abstract concepts and relations, but can also contain instances of objects, such as, for example, documents and datasets. In some embodiments, the knowledge graphs 251 include resource description framework (RDF) graphs. As used herein, a “RDF graph” is a graph data model that formally describes the semantics, or meaning, of information. The RDF graph also represents metadata (e.g., data that describes data). According to various embodiments, knowledge graphs 251 also include a semantic object model. The semantic object model is a subset of a knowledge graph 251 that defines semantics for the knowledge graph 251. For example, the semantic object model defines the schema for the knowledge graph 251.

As used herein, EOM 250 includes a collection of application programming interfaces (APIs) that enables seeded semantic object models to be extended. For example, the EOM 250 of the present disclosure enables a customer's knowledge graph 251 to be built subject to constraints expressed in the customer's semantic object model. Thus, the knowledge graphs 251 are generated by customers (e.g., enterprises or organizations) to create models of the edge devices 161a-161n of an enterprise 160a-160n, and the knowledge graphs 251 are input into the EOM 250 for visualizing the models (e.g., the nodes and links).

The models describe the assets (e.g., the nodes) of an enterprise (e.g., the edge devices 161a-161n) and describe the relationship of the assets with other components (e.g., the links). The models also describe the schema (e.g., describe what the data is), and therefore the models are self-validating. For example, in one or more embodiments, the model describes the type of sensors mounted on any given asset (e.g., edge device 161a-161n) and the type of data that is being sensed by each sensor. According to various embodiments, a KPI framework is used to bind properties of the assets in the extensible object model 250 to inputs of the KPI framework. Accordingly, the IoT platform 125 is an extensible, model-driven end-to-end stack including: two-way model sync and secure data exchange between the edge 115 and the cloud 105, metadata driven data processing (e.g., rules, calculations, and aggregations), and model driven visualizations and applications. As used herein, “extensible” refers to the ability to extend a data model to include new properties/columns/fields, new classes/tables, and new relations. Thus, the IoT platform 125 is extensible with regards to edge devices 161a-161n and the applications 146 that handle those devices 161a-161n. For example, when new edge devices 161a-161n are added to an enterprise 160a-160n system, the new devices 161a-161n will automatically appear in the IoT platform 125 so that the corresponding applications 146 understand and use the data from the new devices 161a-161n.

In some cases, asset templates are used to facilitate configuration of instances of edge devices 161a-161n in the model using common structures. An asset template defines the typical properties for the edge devices 161a-161n of a given enterprise 160a-160n for a certain type of device. For example, an asset template of a pump includes modeling the pump having inlet and outlet pressures, speed, flow, etc. The templates may also include hierarchical or derived types of edge devices 161a-161n to accommodate variations of a base type of device 161a-161n. For example, a reciprocating pump is a specialization of a base pump type and would include additional properties in the template. Instances of the edge device 161a-161n in the model are configured to match the actual, physical devices of the enterprise 160a-160n using the templates to define expected attributes of the device 161a-161n. Each attribute is configured either as a static value (e.g., capacity is 1000 BPH) or with a reference to a time series tag that provides the value. The knowledge graph 251 can automatically map the tag to the attribute based on naming conventions, parsing, and matching the tag and attribute descriptions and/or by comparing the behavior of the time series data with expected behavior. In one or more embodiments, each of the key attribute contributing to one or more metrics to drive a dashboard is marked with one or more metric tags such that a dashboard visualization is generated.

The modeling phase includes an onboarding process for syncing the models between the edge 115 and the cloud 105. For example, in one or more embodiments, the onboarding process includes a simple onboarding process, a complex onboarding process, and/or a standardized rollout process. The simple onboarding process includes the knowledge graph 251 receiving raw model data from the edge 115 and running context discovery algorithms to generate the model. The context discovery algorithms read the context of the edge naming conventions of the edge devices 161a-161n and determine what the naming conventions refer to. For example, in one or more embodiments, the knowledge graph 251 receives “TMP” during the modeling phase and determine that “TMP” relates to “temperature.” The generated models are then published. The complex onboarding process includes the knowledge graph 251 receiving the raw model data, receiving point history data, and receiving site survey data. According to various embodiments, the knowledge graph 251 then uses these inputs to run the context discovery algorithms. According to various embodiments, the generated models are edited and then the models are published. The standardized rollout process includes manually defining standard models in the cloud 105 and pushing the models to the edge 115.

The IoT layer 205 includes one or more components for device management, data ingest, and/or command/control of the edge devices 161a-161n. The components of the IoT layer 205 enable data to be ingested into, or otherwise received at, the IoT platform 125 from a variety of sources. For example, in one or more embodiments, data is ingested from the edge devices 161a-161n through process historians or laboratory information management systems. The IoT layer 205 is in communication with the edge connectors 165a-165n installed on the edge gateways 162a-162n through network 110, and the edge connectors 165a-165n send the data securely to the IoT layer 205. In some embodiments, only authorized data is sent to the IoT platform 125, and the IoT platform 125 only accepts data from authorized edge gateways 162a-162n and/or edge devices 161a-161n. According to various embodiments, data is sent from the edge gateways 162a-162n to the IoT platform 125 via direct streaming and/or via batch delivery. Further, after any network or system outage, data transfer will resume once communication is re-established and any data missed during the outage will be backfilled from the source system or from a cache of the IoT platform 125. According to various embodiments, the IoT layer 205 also includes components for accessing time series, alarms and events, and transactional data via a variety of protocols.

The enterprise integration layer 210 includes one or more components for events/messaging, file upload, and/or REST/OData. The components of the enterprise integration layer 210 enable the IoT platform 125 to communicate with third party cloud applications 211, such as any application(s) operated by an enterprise in relation to its edge devices. For example, the enterprise integration layer 210 connects with enterprise databases, such as guest databases, customer databases, financial databases, patient databases, etc. The enterprise integration layer 210 provides a standard application programming interface (API) to third parties for accessing the IoT platform 125. The enterprise integration layer 210 also enables the IoT platform 125 to communicate with the OT systems 163a-163n and IT applications 164a-164n of the enterprise 160a-160n. Thus, the enterprise integration layer 210 enables the IoT platform 125 to receive data from the third-party applications 211 rather than, or in combination with, receiving the data from the edge devices 161a-161n directly. In certain embodiments, the enterprise integration layer 210 enables a scalable architecture to expand interfaces to multiple systems and/or system configurations. In certain embodiments, the enterprise integration layer 210 enables integration with an indoor navigation system related to the enterprise 160a-160n.

The data pipeline layer 215 includes one or more components for data cleansing/enriching, data transformation, data calculations/aggregations, and/or API for data streams. Accordingly, in one or more embodiments, the data pipeline layer 215 pre-processes and/or performs initial analytics on the received data. The data pipeline layer 215 executes advanced data cleansing routines including, for example, data correction, mass balance reconciliation, data conditioning, component balancing and simulation to ensure the desired information is used as a basis for further processing. The data pipeline layer 215 also provides advanced and fast computation. For example, cleansed data is run through enterprise-specific digital twins. According to various embodiments, the enterprise-specific digital twins include a reliability advisor containing process models to determine the current operation and the fault models to trigger any early detection and determine an appropriate resolution. According to various embodiments, the digital twins also include an optimization advisor that integrates real-time economic data with real-time process data, selects the right feed for a process, and determines optimal process conditions and product yields.

According to various embodiments, the data pipeline layer 215 employs models and templates to define calculations and analytics. Additionally or alternatively, according to various embodiments, the data pipeline layer 215 employs models and templates to define how the calculations and analytics relate to the assets (e.g., the edge devices 161a-161n). For example, in an embodiment, a pump template defines pump efficiency calculations such that every time a pump is configured, the standard efficiency calculation is automatically executed for the pump. The calculation model defines the various types of calculations, the type of engine that should run the calculations, the input and output parameters, the preprocessing requirement and prerequisites, the schedule, etc. According to various embodiments, the actual calculation or analytic logic is defined in the template or it may be referenced. Thus, according to various embodiments, the calculation model is employed to describe and control the execution of a variety of different process models. According to various embodiments, calculation templates are linked with the asset templates such that when an asset (e.g., edge device 161a-161n) instance is created, any associated calculation instances are also created with their input and output parameters linked to the appropriate attributes of the asset (e.g., edge device 161a-161n).

According to various embodiments, the IoT platform 125 supports a variety of different analytics models including, for example, first principles models, empirical models, engineered models, user-defined models, machine learning models, built-in functions, and/or any other types of analytics models. Fault models and predictive maintenance models will now be described by way of example, but any type of models may be applicable.

Fault models are used to compare current and predicted enterprise 160a-160n performance to identify issues or opportunities, and the potential causes or drivers of the issues or opportunities. The IoT platform 125 includes rich hierarchical symptom-fault models to identify abnormal conditions and their potential consequences. For example, in one or more embodiments, the IoT platform 125 drill downs from a high-level condition to understand the contributing factors, as well as determining the potential impact a lower level condition may have. There may be multiple fault models for a given enterprise 160a-160n looking at different aspects such as process, equipment, control, and/or operations. According to various embodiments, each fault model identifies issues and opportunities in their domain, and can also look at the same core problem from a different perspective. According to various embodiments, an overall fault model is layered on top to synthesize the different perspectives from each fault model into an overall assessment of the situation and point to the true root cause.

According to various embodiments, when a fault or opportunity is identified, the IoT platform 125 provides recommendations about an optimal corrective action to take. Initially, the recommendations are based on expert knowledge that has been pre-programmed into the system by process and equipment experts. A recommendation services module presents this information in a consistent way regardless of source, and supports workflows to track, close out, and document the recommendation follow-up. According to various embodiments, the recommendation follow-up is employed to improve the overall knowledge of the system over time as existing recommendations are validated (or not) or new cause and effect relationships are learned by users and/or analytics.

According to various embodiments, the models are used to accurately predict what will occur before it occurs and interpret the status of the installed base. Thus, the IoT platform 125 enables operators to quickly initiate maintenance measures when irregularities occur. According to various embodiments, the digital twin architecture of the IoT platform 125 employs a variety of modeling techniques. According to various embodiments, the modeling techniques include, for example, rigorous models, fault detection and diagnostics (FDD), descriptive models, predictive maintenance, prescriptive maintenance, process optimization, and/or any other modeling technique.

According to various embodiments, the rigorous models are converted from process design simulation. In this manner, process design is integrated with feed conditions and production requirement. Process changes and technology improvement provide opportunities that enable more effective maintenance schedule and deployment of resources in the context of production needs. The fault detection and diagnostics include generalized rule sets that are specified based on industry experience and domain knowledge and can be easily incorporated and used working together with equipment models. According to various embodiments, the descriptive models identifies a problem and the predictive models determines possible damage levels and maintenance options. According to various embodiments, the descriptive models include models for defining the operating windows for the edge devices 161a-161n.

Predictive maintenance includes predictive analytics models developed based on rigorous models and statistic models, such as, for example, principal component analysis (PCA) and partial least square (PLS). According to various embodiments, machine learning methods are applied to train models for fault prediction. According to various embodiments, predictive maintenance leverages FDD-based algorithms to repeatedly monitor individual control and equipment performance. Predictive modeling is then applied to a selected condition indicator that deteriorates in time. Prescriptive maintenance includes determining an optimal maintenance option and when it should be performed based on actual conditions rather than time-based maintenance schedule. According to various embodiments, prescriptive analysis selects the right solution based on the company's capital, operational, and/or other requirements. Process optimization is determining optimal conditions via adjusting set-points and schedules. The optimized set-points and schedules can be communicated directly to the underlying controllers, which enables automated closing of the loop from analytics to control.

The data insight layer 220 includes one or more components for time series databases (TDSB), relational/document databases, data lakes, blob, files, images, and videos, and/or an API for data query. According to various embodiments, when raw data is received at the IoT platform 125, the raw data is stored as time series tags or events in warm storage (e.g., in a TSDB) to support interactive queries and to cold storage for archive purposes. According to various embodiments, data is sent to the data lakes for offline analytics development. According to various embodiments, the data pipeline layer 215 accesses the data stored in the databases of the data insight layer 220 to perform analytics, as detailed above.

The application services layer 225 includes one or more components for rules engines, workflow/notifications, KPI framework, insights (e.g., actionable insights), decisions, recommendations, machine learning, and/or an API for application services. The application services layer 225 enables building of applications 146a-d. The applications layer 230 includes one or more applications 146a-d of the IoT platform 125. For example, according to various embodiments, the applications 146a-d includes a buildings application 146a, a plants application 146b, an aero application 146c, and other enterprise applications 146d. According to various embodiments, the applications 146 includes general applications 146 for portfolio management, asset management, autonomous control, and/or any other custom applications. According to various embodiments, portfolio management includes the KPI framework and a flexible user interface (UI) builder. According to various embodiments, asset management includes asset performance and asset health. According to various embodiments, autonomous control includes energy optimization and/or predictive maintenance. As detailed above, according to various embodiments, the general applications 146 is extensible such that each application 146 is configurable for the different types of enterprises 160a-160n (e.g., buildings application 146a, plants application 146b, aero application 146c, and other enterprise applications 146d).

The applications layer 230 also enables visualization of performance of the enterprise 160a-160n. For example, dashboards provide a high-level overview with drill downs to support deeper investigations. Recommendation summaries give users prioritized actions to address current or potential issues and opportunities. Data analysis tools support ad hoc data exploration to assist in troubleshooting and process improvement.

The core services layer 235 includes one or more services of the IoT platform 125. According to various embodiments, the core services 235 include data visualization, data analytics tools, security, scaling, and monitoring. According to various embodiments, the core services 235 also include services for tenant provisioning, single login/common portal, self-service admin, UI library/UI tiles, identity/access/entitlements, logging/monitoring, usage metering, API gateway/dev portal, and the IoT platform 125 streams.

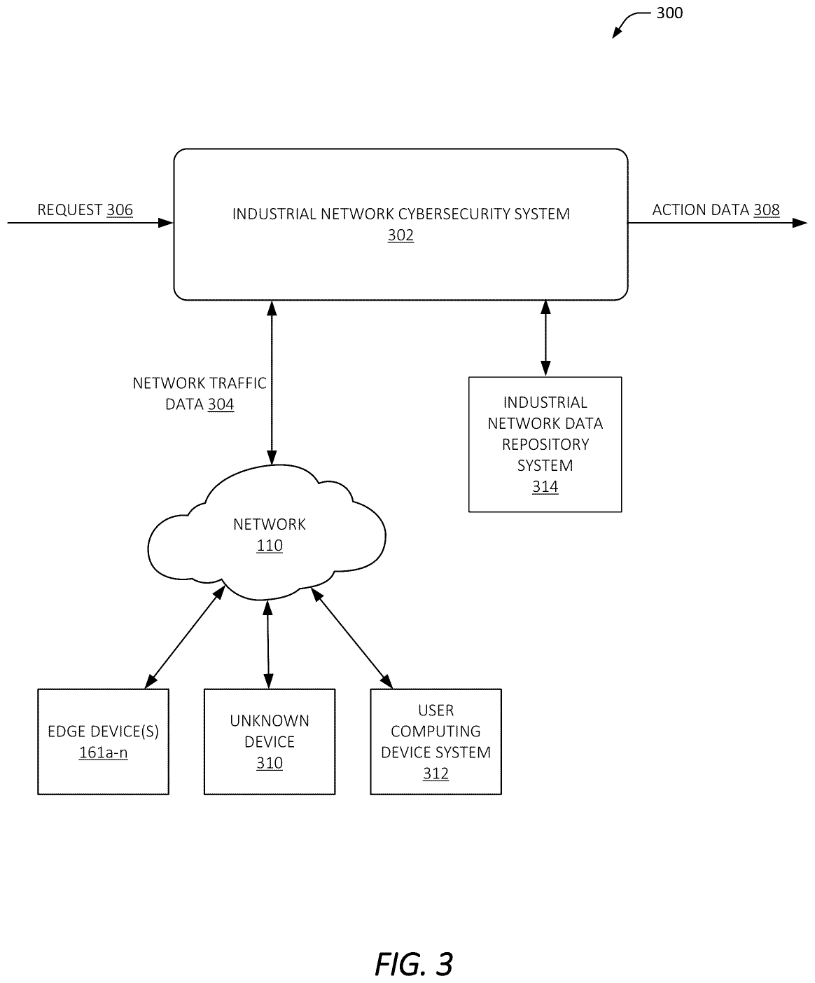

FIG. 3 illustrates a system 300 that provides another exemplary environment according to one or more described features of one or more embodiments of the disclosure. The system 300 includes an industrial network cybersecurity system 302. The industrial network cybersecurity system 302 can be associated with one or more application products such as an asset management platform, an asset performance platform, a global operations platform, a site operations platform, an industrial asset platform, an industrial process platform, an energy and sustainability platform, a healthy buildings platform, an energy optimization platform, a predictive maintenance platform, a centralized control platform, and/or another type of asset platform. In one or more embodiments, the system 300 additionally includes one or more edge devices 161a-n, at least one unknown device 310, and/or a user computing device system 312.

In certain embodiments, the industrial network cybersecurity system 302 receives a request 306 from a user computing device system 312. In certain embodiments, the industrial network cybersecurity system 302 receives the request 306 via the network 110, while in other embodiments the industrial network cybersecurity system 302 receives the request 306 from the user computing device system 312 directly. Additionally, in one or more embodiments, the industrial network cybersecurity system 302 transmits action data 308 to the user computing device system 312. In certain embodiments, the industrial network cybersecurity system 302 transmits the action data 308 via the network 110, while in other embodiments the industrial network cybersecurity system 302 transmits the action data 308 directly to the user computing device system 312.

In one or more embodiments, industrial network cybersecurity system 302 repeatedly (e.g., continuously) monitors an industrial network (e.g., network 110) and collects network traffic data (e.g., network traffic data 304). In various embodiments, the network traffic data 304 is raw network traffic data related to all of the devices communicating on the network 110 such as, for example, edge device(s) 161a-n, one or more unknown device(s) 310, and/or user computing device system 312. In one or more embodiments, the edge devices 161a-161n are associated with a portfolio of IoT asset devices capable of communicating with both wired and wireless devices via the network 110. The edge devices 161a-161n include, in one or more embodiments, one or more databases, one or more assets (e.g., one or more industrial assets, one or more building assets, etc.), one or more IoT devices (e.g., one or more industrial IoT devices), one or more connected building assets, one or more sensors, one or more actuators, one or more processors, one or more computers, one or more valves, one or more pumps (e.g., one or more centrifugal pumps, etc.), one or more motors, one or more compressors, one or more turbines, one or more ducts, one or more heaters, one or more chillers, one or more coolers, one or more boilers, one or more furnaces, one or more heat exchangers, one or more fans, one or more blowers, one or more conveyor belts, one or more vehicle components, one or more cameras, one or more displays, one or more security components, one or more air handler units, one or more HVAC components, industrial equipment, factory equipment, and/or one or more other devices that are connected to the network 110 for collecting, sending, and/or receiving information. In one or more embodiments, the edge device(s) 161a-161n include, or are otherwise in communication with, one or more controllers for selectively controlling a respective edge device 161a-161n and/or for sending/receiving information between the edge devices 161a-161n and the industrial network cybersecurity system 302 via the network 110.

In various embodiments, the network traffic data 304 comprises metadata related to each of the one or more devices communicating on the network 110 including, but not limited to, the type of device (wired or wireless), the model and/or vendor of the device, address information (e.g., IP and/or MAC address data), networking protocols, data transmission timestamp information, and/or various configuration parameters associated with the device. As the industrial network cybersecurity system 302 repeatedly collects the network traffic data 304, the industrial network cybersecurity system 302 can store the network traffic data 304 in a repository comprised in the industrial network data repository system 314.

In one or more embodiments, the industrial network cybersecurity system 302 can process the network traffic data 304 and standardize the network traffic data 304 into a structured digital format. For example, the industrial network cybersecurity system 302 generates asset device instances for each device communicating on the network 110, where the asset device instances can be electronically managed data objects containing structured metadata related to the devices communicating on the industrial network. In one or more embodiments, the asset device instances comprise metadata related to, but not limited by, asset device identifiers, MAC addresses, IP addresses, hostnames, vendor names, operating system identifiers, data related to networking protocols being employed by the asset devices (e.g., TCP and/or UDP), device status (e.g., “pending,” or “under investigation”), and/or other data. Additionally or alternatively, the asset device instances can comprise historical log data such as timestamp data, identifiers corresponding to various networking devices (e.g., networking switch and/or router addresses) used by the asset device during transmission, port numbers used, and/or other descriptions.

In one or more embodiments, the industrial network cybersecurity system 302 generates and maintains baseline asset data in the industrial network data repository system 314. The baseline asset data comprises asset device instances corresponding to one or more respective trusted devices approved to communicate on the industrial network 110. The asset device instances in the baseline asset data also comprise various configuration parameters related to the one or more respective trusted devices that dictate various operating configurations. Additionally, in various embodiments, the industrial network cybersecurity system 302 automatically generates asset device instances for any new unknown device (e.g., unknown device 310) communicating on the industrial network 110 and stores the asset device instances in the industrial network data repository system for to facilitate analysis and classification.

In one or more embodiments, the industrial network cybersecurity system 302 can analyze the network traffic data 304 and classify the devices communicating on the network 110. For example, if the industrial network cybersecurity system 302 detects that unknown device 310 is communicating on the network 110, the industrial network cybersecurity system 302 can analyze the network traffic data 304 to determine what type of device the unknown device 310 is (e.g., wired or wireless) using various pieces of metadata. For instance, the industrial network cybersecurity system 302 can use the metadata comprised in the asset device instance associated with the unknown device 310 to identify and classify the unknown device 310. For instance, the industrial network cybersecurity system 302 can use the associated asset device instance to determine the networking protocols used by the unknown device 310 to classify the unknown device 310 as wired or wireless. The industrial network cybersecurity system 302 can also use historical log data associated with said asset device instance to identify which other devices the unknown device 310 has communicated with and which networking devices (e.g., switches, routers) the unknown device 310 used to transmit data. The industrial network cybersecurity system 302 also captures the same information from approved devices (e.g., edge device(s) 161a-n) as the approved devices communicate on the network 110.

In one or more embodiments, the industrial network cybersecurity system 302 compiles a device list comprising one or more asset device instances associated with the edge devices 161a-n and the one or more unknown device(s) 310 communicating on the network 110. The industrial network cybersecurity system 302 can then employ a cybersecurity event component to compare the device list to the baseline asset data associated with the industrial network. Based on the comparison between the device list and the baseline asset data, the industrial network cybersecurity system 302 can determine whether the one or more unknown device(s) 310 are trusted devices. For example, the industrial network cybersecurity system 302 can determine that edge device(s) 161a-n communicating on the network 110 are trusted devices by comparing the respective asset device instances in the device list to the baseline asset data stored in the industrial network data repository system 314. As a result of this comparison, the industrial network cybersecurity system 302 can also determine that unknown device 310 is not a trusted device and has not been approved to communicate on the network 110. In such cases, the industrial network cybersecurity system 302 can automatically update the metadata comprised in the asset device instance associated with the unknown device 310 to mark the state of the unknown device 310 as “pending” and transmit a notification comprising the details of the unknown device 310 communicating on the network 110. In one or more embodiments, the industrial network cybersecurity system 302 can send such a notification regarding the unknown device 310 to a user computing device system 312 as part of the action data 308.

As mentioned above, the industrial network cybersecurity system 302 can employ a cybersecurity event component to compare the network traffic data 304 and the baseline asset data associated with the industrial network to classify and identify any unknown device(s) 310 that have been connected to the network 110. Based on these comparisons, the industrial network cybersecurity system 302 can also determine whether any modifications to the configuration parameters associated with any respective edge device(s) 161a-n devices have been made, as well as detect any unusual and/or malicious activity by any devices communicating on the industrial network. The industrial network cybersecurity system 302 can transmit the results of these comparisons as action data 308 to a user computing device system 312 in various ways including, but not limited to, alerts, notifications, alarm triggers, generated networking event reports, and more. Additionally, the action data 308 generated while comparing the network traffic data 304 and the baseline asset data associated with the network 110 can also be rendered on an interactive user dashboard (e.g., interactive user dashboard 700) generated by the industrial network cybersecurity system 302 on the user computing device system 312.

In one or more embodiments, each one of an identification of a new device, an identification of a modification in configuration parameters, and/or a detection of suspicious activity on the network 110 can be compiled into a respective networking event (e.g., networking event(s) 714a-n) comprising any metadata related to the associated asset devices and any information related to the networking event itself. Data related to such networking events can be transmitted to a user computing device system 312 associated with the network 110 as part of the action data 308 and can be rendered, among other information, on an interactive user dashboard (e.g., interactive user dashboard 700) on the user computing device system 312. In various embodiments, networking events (e.g., networking event(s) 714a-n) comprise metadata related to a networking event type, an asset device identifier, an asset device address, a cybersecurity event level, a networking event description, networking event timestamp information, a networking event status, and/or a responsible administrator identifier.

In one or more embodiments, the industrial network cybersecurity system 302 can employ a plurality of networking event rules and configurations detailing how asset devices may communicate on the network 110 and which networking events will trigger an alarm. As mentioned above, the industrial network cybersecurity system 302 can compare the network traffic data 304 to the baseline asset data associated with the network 110. In one or more embodiments, the plurality of network event rules can be configured by a user computing device system 312 associated with the industrial network. In various embodiments the user computing device system 312 can configure one or more networking event rules associated with one or more respective cybersecurity event levels. Cybersecurity event levels can include, but are not limited to, “critical,” “high,” “moderate,” and “informational.” Additionally, in some embodiments, networking events of varying severity can also be assigned to respective categories classifying the type of networking event. For instance, a rule pertaining to unusual activity being performed by edge device(s) 161a-n on the network 110 can be defined as a “security event” with a cybersecurity event level of “critical,” whereas a rule pertaining to an administrative change made to a group policy via the user computing device system 312 can be defined as a “Windows event” with a cybersecurity event level of “high.” Additionally and/or alternatively, in various embodiments, one or more of the plurality of rules employed by the industrial network cybersecurity system 302 can reflect international cybersecurity standards for industrial networks (e.g., ISA/IEC 62443) and respective cybersecurity event levels can be attributed to the networking event rules associated with the international standards.

When the industrial network cybersecurity system 302 detects a networking event that exceeds a predefined cybersecurity threat level threshold (e.g., networking events with a “high” or “critical” cybersecurity event level), certain automatic actions can then be executed. In the event that a networking event associated with a high or critical cybersecurity event level occurs, the industrial network cybersecurity system 302 can trigger one or more alarms, determine an automatic cybersecurity threat mitigation action to execute on the network 110, and/or modify one or more configuration parameters associated with the one or more asset devices associated with the cybersecurity event. For example, if a networking event has a cybersecurity event level of high or critical (e.g., networking event 714c), the industrial network cybersecurity system 302 can trigger an alarm and render various notifications and on an interactive user dashboard (e.g., interactive user dashboard 700) of a user computing device system (e.g., user computing device system 312) to prompt expedited action with respect to the cybersecurity event. In various embodiments, the industrial network cybersecurity system 302 can also transmit notifications and alerts associated with networking events to one or more user devices (e.g., via email and/or SMS) such that no networking event associated with a cybersecurity event level that satisfies a predefined cybersecurity threat level threshold goes unacknowledged. In one or more embodiments, the industrial network cybersecurity system 302 can execute automatic cybersecurity threat mitigation actions to mitigate cybersecurity threats as the cybersecurity threats are detected.

Such cybersecurity threat mitigation techniques can stop an adverse networking event quickly without the need for manual intervention, thus mitigating the cybersecurity threat and/or improving performance of an industrial network. For example, if the industrial network cybersecurity system 302 detects a networking event associated with a cybersecurity event level categorized as “critical” such as, for example, detecting unusual activity on the network 110 from an asset device (e.g., edge device 161a) with privileged user access permissions, the industrial network cybersecurity system 302 can temporarily decommission the associated asset device such that the associated asset device can make no further communications on the network 110 until the networking event can be reviewed. Likewise, if an unauthorized “insider” (e.g., a user employed by the industrial enterprise) is repeatedly attempting to access a secure part of the industrial network (e.g., the industrial network data repository system 314) from a particular asset device (e.g., edge device 161a), the industrial network cybersecurity system 302 can automatically decommission the asset device, flag the user account in question, and/or transmit an alert to a user device with the details of the networking event.

In one or more embodiments, decommissioning an asset device (e.g., edge device 161a-n) can include at least one of, but is not limited to, de-powering or putting the device into a stand-by mode, modifying one or more configuration parameters associated with the asset device, changing user access permissions associated with the asset device, storing identifying information associated with the asset device on a “blacklist” in the industrial network data repository system (e.g., MAC addresses, IP addresses, and/or any other metadata associated with the asset device), and/or otherwise ensuring the asset device can no longer communicate on the network 110.

In one or more embodiments, the industrial network cybersecurity system 302 is configured to receive the request 306, where the request 306 is generated by the user computing device system 312. In one or more embodiments, the request 306 can be a request to update and/or modify the configuration parameters associated with an edge device 161a-n, a request to poll any asset devices communicating on the network 110 for identifying information, a request to create, update, and/or remove an asset device instance associated with an asset device communicating on the network 110, a request to create, update, and/or remove a networking event rule, a request to generate a networking event report (e.g., networking event report 710), a request to export and/or transmit at least of portion of the data rendered on an interactive user dashboard (e.g., interactive user dashboard 700), a request to approve an asset device for communicating on the industrial network, a request to decommission an asset device in the industrial network, and/or a request to start or stop collecting network traffic data 304 from the network 110.

In one or more embodiments, the industrial network cybersecurity system 302 can generate action data 308 in response to receiving the request 306. In one or more embodiments, the action data 308 includes one or more visual elements for a visual display (e.g., as rendered by the electronic interface component 508) of the user computing device system 312 that renders an interactive user dashboard (e.g., interactive user dashboard 700) based on a respective configuration of the action data 308. For example, the industrial network cybersecurity system 302 can cause a rendering of visualization data associated with any data related to the network traffic data 304, comparison result data generated by comparing portions of the network traffic data 304 that have been standardized (e.g., standardized asset device instances associated with the devices communicating on the network 110) to the baseline asset data comprised within the industrial network data repository system 314, networking event data, data generated by comparisons made by the various components of industrial network cybersecurity system 302, data to be rendered on the interactive user dashboard, networking event reports, alarms and alerts for networking events satisfying predefined cybersecurity threat level thresholds, notifications regarding networking events, and/or any data associated with the one or more devices communicating on the network 110.

In various embodiments, the rendering of the action data 308 on the interactive user interface (e.g., interactive user dashboard 700) can be caused via one or more computer-executable instructions included in the action data 308. In certain embodiments, the visual display of the user computing device system 312 displays one or more graphical elements associated with the action data 308. In certain embodiments, the electronic interface component 508 of the user computing device system 312 renders one or more interactive display elements associated with the action data 308. In certain embodiments, the industrial network cybersecurity system 302 can configure the electronic interface to render interactive graphs, pie charts, buttons, hyperlinks, tables, and/or the like related to the action data 308.

In another example, in one or more embodiments, the action data 308 includes one or notifications associated with the action data 308. In one or more embodiments, the action data 308 can be used by the user computing device system 312 to make decisions and/or perform one or more actions with respect to configuring parameters associated with the asset devices associated with the industrial network, updating the status of the one or more asset devices communicating on the network 110, approving one or more asset devices to communicate on the industrial network, decommissioning one or more asset devices, configuring one or more networking event rules of the industrial network cybersecurity system 302, and/or generating and exporting networking event reports.

In one or more embodiments, the unknown device 310 is integrated within or corresponds to a mobile computing device, a smartphone, a tablet computer, a mobile computer, a desktop computer, a laptop computer, a workstation computer, a wearable device, a virtual reality device, an augmented reality device, or another type of computing device capable of communicating on the network 110. In various embodiments, the unknown device 310 can be a field tool used by a field operator associated with the industrial enterprise related to the industrial network that is being used to interface with one or more edge device(s) 161a-n. In various embodiments an unknown device 310 can be a wired or wireless device communicating on the network 110 and can be classified and identified by the industrial network cybersecurity system 302.

In one or more embodiments, the user computing device system 312 is in communication with the industrial network cybersecurity system 302 via the network 110. In one or more embodiments, the user computing device system 312 is integrated within or corresponds to a mobile computing device, a smartphone, a tablet computer, a mobile computer, a desktop computer, a laptop computer, a workstation computer, a wearable device, a virtual reality device, an augmented reality device, or another type of computing device located remote from the industrial network cybersecurity system 302. In certain embodiments, the industrial network cybersecurity system 302 receives the request 306 via the network 110, while in other embodiments the industrial network cybersecurity system 302 receives the request 306 from the user computing device system 312 directly. Additionally, in one or more embodiments, the industrial network cybersecurity system 302 transmits the action data 308 to the user computing device system 312. In certain embodiments, the industrial network cybersecurity system 302 transmits the action data 308 via the network 110, while in other embodiments the industrial network cybersecurity system 302 transmits the action data 308 directly to the user computing device system 312.

In various embodiments, the industrial network data repository system 314 comprises one or more databases configured as non-transitory computer-readable storage mediums. The industrial network data repository system 314 and any databases comprised therein include hardware, software, firmware, and/or a combination thereof capable of storing, recording, updating, retrieving and/or deleting computer readable data and information. In some embodiments, the industrial network data repository system 314 can be configured as a set of one or more databases each storing respective portions of data associated with the industrial network, all of which are interconnected and managed by the industrial network cybersecurity system 302. For instance, in one or more embodiments, the industrial network data repository system 314 can comprise, an asset device database comprising information about each asset device, including unknown devices, an asset metadata database comprising information about each respective asset device in the asset device database including, but not limited to, timestamped data associated with the networking devices the asset device used to communicate, and/or an asset device log database comprising information related to historical log and operation information associated to each respective asset device in the asset device database.

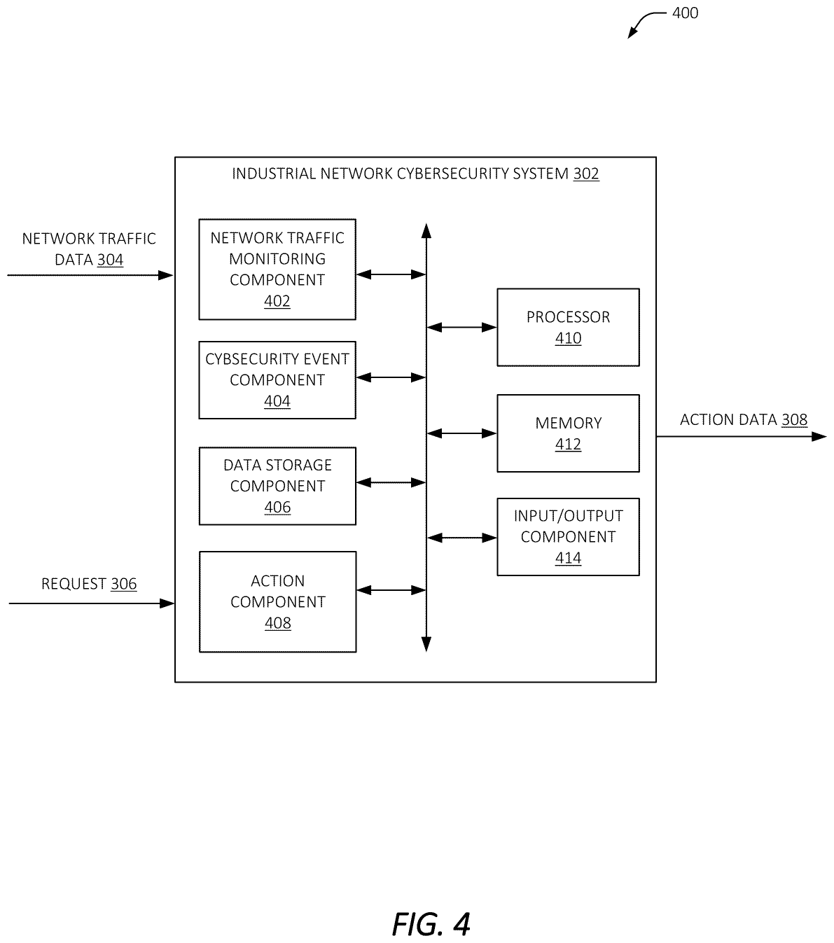

FIG. 4 illustrates a system 400 that provides an exemplary environment according to one or more described features of one or more embodiments of the disclosure. Specifically, the system 400 details the exemplary industrial network cybersecurity system 302 (first introduced in FIG. 3) to provide a practical application of mitigating cybersecurity threats for an industrial network. In various embodiments, the industrial network cybersecurity system 302 provides a practical application of data analytics technology to facilitate configuration and standardization of structured asset device instances associated with asset devices (e.g., edge device(s) 161a-n) communicating on an industrial network. In one or more embodiments, the industrial network cybersecurity system 302 provides a practical application of receiving requests to generate device lists comprising the asset device instances associated with trusted and untrusted devices communicating on the network 110, executing comparisons of said trusted and untrusted devices to baseline asset data and configurations comprised in an industrial network data repository system, classifying one or more networking events occurring on the network 110, mitigating cybersecurity threats associated with the one or more networking events, and/or generating networking event reports detailing the one or more networking events. In one or more embodiments, the industrial network cybersecurity system 302 provides a practical application of transmitting action data (e.g., action data 308) comprising visual representations of said device lists, asset device instances associated with trusted and untrusted devices communicating on the network 110, comparisons of said trusted and untrusted devices to baseline asset data and configurations comprised in the industrial network data repository system, the classifications of the one or more networking events, and/or the networking event reports detailing the networking events.

In an embodiment, the industrial network cybersecurity system 302 works in conjunction with a data repository system (e.g., industrial network data repository system 314), one or more data sources, and/or one or more asset devices associated with an industrial environment. In one or more embodiments, the industrial network cybersecurity system 302 comprises one or more processors and a memory. In one or more embodiments, the industrial network cybersecurity system 302 interacts with a computer system from the computer systems 120 to facilitate securing the industrial network to mitigate cybersecurity threats in accordance with various embodiments of the present disclosure. In one or more embodiments, the industrial network cybersecurity system 302 interacts with a computer system from the computer systems 120 via the network 110. In various embodiments, the industrial network cybersecurity system 302 is to, among other things, generate one or more device lists, one or more asset device instances associated with trusted and untrusted devices communicating on the network 110, one or more comparisons of said trusted and untrusted devices to baseline asset data and configurations comprised in an industrial network data repository system, a classification of one or more networking events, and/or one or more networking event reports detailing the one or more networking events occurring on the network 110 associated with a particular industrial environment.

The industrial network cybersecurity system 302 is also related to one or more technologies, such as, for example, enterprise technologies, industrial technologies, connected building technologies, Internet of Things (IoT) technologies, user interface technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, process plant technologies, procurement technologies, and/or one or more other technologies.

Moreover, the industrial network cybersecurity system 302 provides an improvement to one or more technologies such as enterprise technologies, industrial technologies, connected building technologies, IoT technologies, user interface technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, process plant technologies, procurement technologies, and/or one or more other technologies. In an implementation, the industrial network cybersecurity system 302 improves performance of a user computing device. For example, in one or more embodiments, the industrial network cybersecurity system 302 improves processing efficiency of a user computing device, reduces power consumption of a computing device, improves quality of data provided by a user computing device, etc. In various embodiments, the industrial network cybersecurity system 302 improves performance of a user computing device by optimizing content rendered via an interactive user interface, by reducing a number of user interactions with respect to an interactive user interface, and/or by reducing a number of computing resources required to render content via an interactive user interface.

The industrial network cybersecurity system 302 includes a network traffic monitoring component 402, a cybersecurity event component 404, a data storage component 406, and/or a action component 408. Additionally, in one or more embodiments, the industrial network cybersecurity system 302 includes a processor 410, a memory 412, and/or an input/output component 414. In certain embodiments, one or more aspects of the industrial network cybersecurity system 302 (and/or other systems, apparatuses and/or processes disclosed herein) constitute executable instructions embodied within a computer-readable storage medium (e.g., the memory 412). For instance, in an embodiment, the memory 412 stores computer executable component and/or executable instructions (e.g., program instructions). Furthermore, the processor 410 facilitates execution of the computer executable components and/or the executable instructions (e.g., the program instructions). In an example embodiment, the processor 410 is configured to execute instructions stored in the memory 412 or otherwise accessible to the processor 410.

The processor 410 is a hardware entity (e.g., physically embodied in circuitry) capable of performing operations according to one or more embodiments of the disclosure. Alternatively, in an embodiment where the processor 410 is embodied as an executor of software instructions, the software instructions configure the processor 410 to perform one or more algorithms and/or operations described herein in response to the software instructions being executed. In an embodiment, the processor 410 is a single core processor, a multi-core processor, multiple processors internal to the industrial network cybersecurity system 302, a remote processor (e.g., a processor implemented on a server), and/or a virtual machine. In certain embodiments, the processor 410 is in communication with the memory 412, the network traffic monitoring component 402, the cybersecurity event component 404, the data storage component 406, and/or the action component 408 via a bus to, for example, facilitate transmission of data among the processor 410, the memory 412, the input/output component 414, the network traffic monitoring component 402, the cybersecurity event component 404, the data storage component 406, and/or the action component 408. The processor 410 may be embodied in a number of different ways and, in certain embodiments, includes one or more processing devices configured to perform independently. Additionally or alternatively, in one or more embodiments, the processor 410 includes one or more processors configured in tandem via a bus to enable independent execution of instructions, pipelining of data, and/or multi-thread execution of instructions.

The memory 412 is non-transitory and includes, for example, one or more volatile memories and/or one or more non-volatile memories. In other words, in one or more embodiments, the memory 412 is an electronic storage device (e.g., a computer-readable storage medium). The memory 412 is configured to store information, data, content, one or more applications, one or more instructions, or the like, to enable industrial network cybersecurity system 302 to carry out various functions in accordance with one or more embodiments disclosed herein. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor, circuitry, an executable component, a thread of instructions, a program, and/or a computer entity.

In one or more embodiments, the input/output component 414 is configured to receive a request 306 (e.g., such as from user computing device system 312). In various embodiments, the input/output component 414 can relay the request 306 to the network traffic monitoring component 402, the cybersecurity event component 404, the data storage component 406, and/or the action component 408 for processing and/or compiling action data 308. Once the action data 308 has been compiled (e.g., as by the network traffic monitoring component 402, the cybersecurity event component 404, the data storage component 406, and/or the action component 408), the input/output component 414 can transmit the action data 308 to one or more user computing device system(s) 312.

In various embodiments, the network traffic monitoring component 402, the cybersecurity event component 404, the data storage component 406, and/or the action component 408 embody executable computer program code and/or interface with one or more computer programs and/or computer hardware configured to employ cybersecurity conventions to secure an industrial network and mitigate cybersecurity threats to any device, system, and/or network associated with one or more industrial processes in an industrial environment. In various embodiments, the one or more industrial processes are related to the edge devices 161a-161n (e.g., the edge devices 161a-161n included in a portfolio of assets). In one or more embodiments, the edge devices 161a-161n are associated with the portfolio of assets. For instance, in one or more embodiments, the edge devices 161a-161n include one or more assets in a portfolio of assets. The edge devices 161a-161n include, in one or more embodiments, one or more databases, one or more assets (e.g., one or more building assets, one or more industrial assets, etc.), one or more IoT devices (e.g., one or more industrial IoT devices), one or more connected building assets, one or more sensors, one or more actuators, one or more processors, one or more computers, one or more valves, one or more pumps (e.g., one or more centrifugal pumps, etc.), one or more motors, one or more compressors, one or more turbines, one or more ducts, one or more heaters, one or more chillers, one or more coolers, one or more boilers, one or more furnaces, one or more heat exchangers, one or more fans, one or more blowers, one or more conveyor belts, one or more vehicle components, one or more cameras, one or more displays, one or more security components, one or more air handler units, one or more HVAC components, industrial equipment, factory equipment, and/or one or more other devices that are connected to the network 110 for collecting, sending, and/or receiving information. In one or more embodiments, the edge device 161a-161n include, or is otherwise in communication with, one or more controllers for selectively controlling a respective edge device 161a-161n and/or for sending/receiving information between the edge devices 161a-161n and an industrial network cybersecurity system via the network 110. In one or more embodiments, the edge devices 161a-161n are associated with an industrial environment (e.g., an industrial plant, etc.). Additionally or alternatively, in one or more embodiments, the edge devices 161a-161n are associated with components of the edge 115 such as, for example, one or more enterprises 160a-160n.

In one or more embodiments, the network traffic monitoring component 402 can repeatedly monitor network 110 and aggregate the data associated with the edge devices 161a-161n from the edge devices 161a-161n communicating on the network 110. For instance, in one or more embodiments, the network traffic monitoring component 402 aggregates the network traffic data 304 on network 110 related to the edge devices 161a-161n, as well as any unknown device(s) 310 communicating on the network 110, into an industrial network data repository system 314. Additionally, in one or more embodiments, the network traffic monitoring component 402 can organize and standardize the network traffic data 304 and store the standardized network traffic data in the industrial network data repository system 314. For example, the network traffic monitoring component 402 can generate one or more asset device instances associated with the edge device(s) 161a-n and the unknown device 310 and store the asset device instances in the industrial network data repository system 314.

Additionally, the network traffic monitoring component 402 is configured to collect and process historical log data associated with the edge device(s) 161a-n and the unknown device(s) 310. In one or more embodiments, the historical log data associated with edge device(s) 161a-n and the unknown device(s) 310 comprises data related to timestamp data, identifiers corresponding to various networking devices (e.g., networking switch and/or router addresses) used by the edge device(s) 161a-n and the unknown device(s) 310 during data transmission, port numbers used by the devices, as well as other descriptions. Once the historical log data has been processed, the network traffic monitoring component 402 can associate the historical log data with the respective asset device instances associated with the edge device(s) 161a-n and the unknown device(s) 310 and update the respective asset device instances in the industrial network data repository system 314. In various embodiments, historical log data associated with a particular asset device can be updated in response to an interaction with an interactive user dashboard rendered by the industrial network cybersecurity system 302 (e.g., interactive user dashboard 700). For example, based on an interaction with the interactive user dashboard 700, a request 306 can be transmitted to the industrial network cybersecurity system 302 to update, via the network traffic monitoring component 402, the metadata associated with the description for a particular asset device instance.

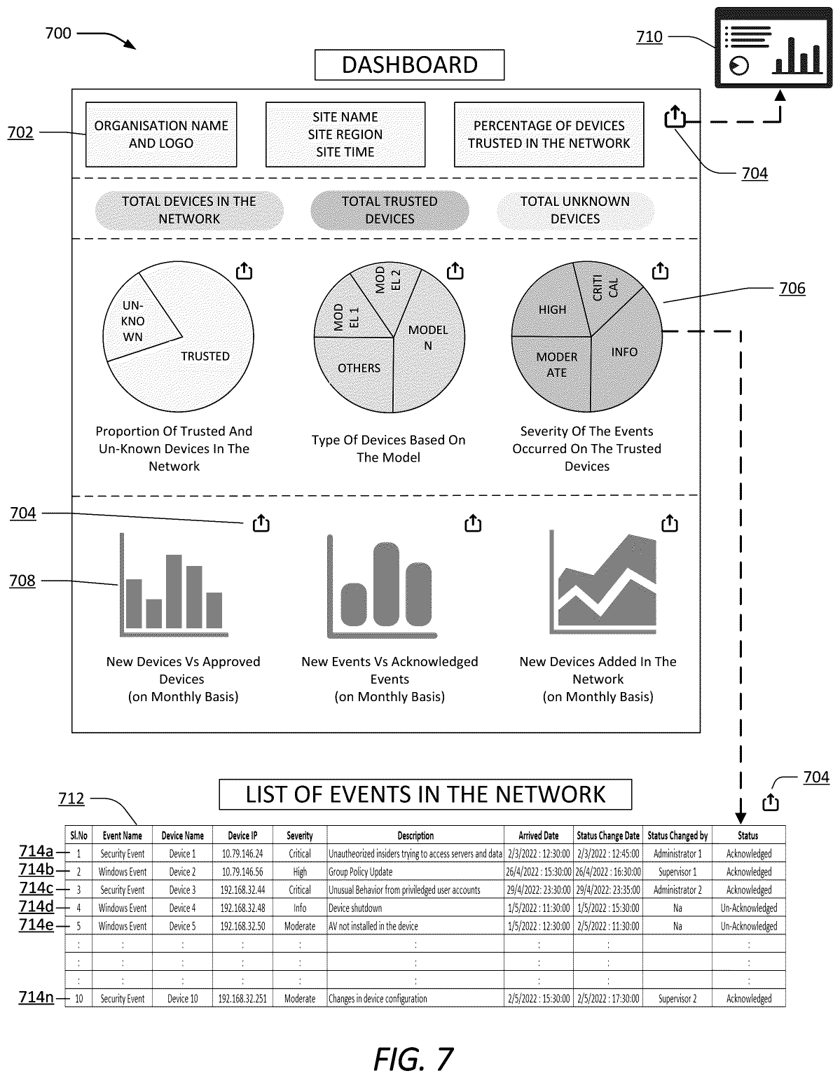

In one or more embodiments, the network traffic monitoring component 402 can generate networking events (e.g., networking events 714a-n illustrated in FIG. 7). In one or more embodiments, each one of an identification of a new device, a detection of a modification in configuration parameters associated with one or more edge device(s) 161a-n, and/or a detection of suspicious activity by one or more devices on the network 110 can be compiled into a respective networking event (e.g., networking event(s) 714a-n) comprising a networking event feature set corresponding to any metadata related to the associated asset devices and any information related to the networking event itself. Data related to such networking events can be transmitted to a user computing device system 312 as part of the action data 308 and can be rendered, among other information, on an interactive user dashboard (e.g., interactive user dashboard 700 illustrated in FIG. 7) on the user computing device system 312 associated with the network 110. In various embodiments, networking events comprise metadata related to a networking event type, an asset device identifier, an asset device address, a cybersecurity event level, a networking event description, networking event timestamp information, a networking event status, and/or a responsible administrator identifier. In one or more embodiments, the network traffic monitoring component 402 can, in conjunction with the data storage component 406, store and/or update the industrial network data repository system 314 with any data related to the network traffic data 304, data related to any of the one or more asset device instances associated with the devices communicating on the network 110, historical log data associated the asset devices communicating on the network 110, and/or any data related to the one or more networking events taking place on the network 110.

In various embodiments, types of networking events can be related to, but are not limited by, detected signal strength data associated with an asset device communicating on the network 110, a type of wireless protocol, a beacon event, a probing event, an authentication event, a data frame event, a network address sharing event, detected radio frequency signals collected from the airspace of the industrial environment associated with the industrial network, and/or another type of networking event. The types of networking events can additionally or alternatively be related to suspicious activity related to, but not limited by, unauthorized access where an unknown user is trying to access one or more asset devices, unusual activity performed by a user after gaining access to the one or more asset devices, anomalies in inbound and outbound industrial network traffic, detection of an untrusted device in the network, threats from internal users known as “insider threats,” as well as malicious activity related to know types of malware. In various embodiments, said types of suspicious activity can correspond to a predefined cybersecurity event feature set corresponding to a respective, predefined cybersecurity event of a set of predefined cybersecurity events stored in the industrial network data repository system 314.

In one or more embodiments, the industrial network cybersecurity system 302 comprises a cybersecurity event component 404 comprising a plurality of networking event rules and configurations detailing how asset devices may communicate on the network 110 and which networking events will trigger an alarm. In one or more embodiments, the cybersecurity event component 404 can configure one or more networking event rules of the plurality of networking event rules comprised in the cybersecurity event component 404 based on a request 306 received from a user computing device system 312 associated with the industrial network. In various embodiments the cybersecurity event component 404 can configure one or more networking event rules associated with one or more respective cybersecurity event levels. Cybersecurity event levels can include, but are not limited to, “critical,” “high,” “moderate,” and “informational.” Additionally, in some embodiments, networking events of varying severity can also be assigned to respective categories classifying the type of networking event. For instance, a rule pertaining to unusual activity being performed by edge device(s) 161a-n on the network 110 can be defined as a “security event” with a cybersecurity event level of “critical,” whereas a rule pertaining to an administrative change made to a group policy via the user computing device system 312 can be defined as a “Windows event” with a cybersecurity event level of “high.” Additionally and/or alternatively, in various embodiments, one or more of the plurality of rules comprised in the cybersecurity event component 404 of the industrial network cybersecurity system 302 can reflect international cybersecurity standards for industrial networks (e.g., ISA/IEC 62443) and respective cybersecurity event levels can be attributed to the networking event rules associated with the international standards.

In one or more embodiments, the cybersecurity event component 404 works in conjunction with the action component 408 to determine whether a device communicating on the network 110 is a trusted device and/or whether a networking event classifies as a cybersecurity threat. For example, the industrial network cybersecurity system 302 can employ the cybersecurity event component 404 and the action component 408 to compare any network traffic data 304 that has been standardized (e.g., asset device instances standardized from the network traffic data 304) to the baseline asset data associated with the network 110. As another example, the action component 408 can use the plurality of networking event rules configured by the cybersecurity event component 404 to determine whether a particular networking event exceeds a predefined cybersecurity threat level threshold. In the event the determination is made that the particular networking event exceeds a predetermined cybersecurity event threat level threshold, the industrial network cybersecurity system 302 can modify one or more configuration parameters associated with one or more asset devices (e.g., edge device(s) 161a-n and/or one or more unknown device(s) 310) associated with the networking event.

In one or more embodiments, the industrial network cybersecurity system 302 comprises a data storage component 406 that integrates with the industrial network data repository system 314. In various embodiments, the data storage component 406 works in conjunction with the various components of the industrial network cybersecurity system 302 to store, update, retrieve, remove, and/or otherwise manage data related to, but not limited by, data associated with any asset devices communicating on the network 110, data related to any networking events that occur on the network 110, data related to any networking event rules, network traffic data 304, action data 308, historical log data associated with any asset devices that have communicated on the network 110, whitelists associated with trusted asset devices, blacklists associated with untrusted asset devices, and/or any data otherwise collected and/or processed by the industrial network cybersecurity system 302. For example, the data storage component 406 can work in conjunction with the network traffic monitoring component 402 to store the network traffic data 304 in the industrial network data repository system 314.

In various embodiments, the data storage component 406 is configured to manage any of the one or more databases comprised by the industrial network data repository system 314. In some embodiments, the industrial network data repository system 314 can be configured as a set of one or more databases each storing respective portions of data associated with the industrial network, all of which are interconnected and can be managed by the data storage component 406. For instance, in one or more embodiments, the industrial network data repository system 314 can comprise, an asset device database comprising information about each asset device, including unknown devices, an asset metadata database comprising information about each respective asset device in the asset device database including, but not limited to, timestamped data associated with the networking devices the asset device used to communicate, and/or an asset device log database comprising information related to historical log and operation information associated to each respective asset device in the asset device database.

In one or more embodiments, the industrial network cybersecurity system 302 comprises a action component 408 that works with various components of the industrial network cybersecurity system 302 to analyze and classify networking events to mitigate cybersecurity threats to the industrial network. For example, the action component 408 can work in conjunction with the network traffic monitoring component 402 and the cybersecurity event component 404 to compare network traffic data 304, one or more asset data instances, and/or one or more portions of historical log data associated with one or more asset devices to baseline asset data and/or a set of networking event rules comprised in the industrial network data repository system 314 to classify networking events taking place on the network 110. The action component 408 can determine, based on a comparison between a networking event feature set for a particular networking event and a predefined cybersecurity event feature set for a set of predefined cybersecurity events, a cybersecurity event level for the networking event. If the action component 408 determines that the cybersecurity event level for the networking event satisfies a predefined cybersecurity threat level threshold, the action component 408 can cause, in conjunction with processor 410, a modification to one or more configuration parameters for one or more asset devices from the set of asset devices associated with the networking event.

For example, the action component 408 can compare a networking event that is currently taking place in real time to a set of predefined cybersecurity events. If, based on the comparison, the action component 408 determines that the current networking event corresponds to a predefined cybersecurity event categorized as having a “high” cybersecurity event level, the action component 408 can classify the networking event that is currently taking place as having a high cybersecurity event level. After classifying the cybersecurity event level of the networking event that is currently taking place, the action component 408 can determine if the networking event satisfies a predefined cybersecurity threat level threshold defined by the cybersecurity event component 404. If the action component 408 determines that the networking event satisfies the predefined cybersecurity threat level threshold, certain automatic actions can be executed.

In the event that a networking event associated with a high or critical cybersecurity event level occurs, the action component 408 can trigger one or more alarms, determine an automatic cybersecurity threat mitigation action to execute on the network 110, and/or modify one or more configuration parameters associated with the one or more asset devices associated with the networking event. For example, if a networking event has a cybersecurity event level of high or critical (e.g., networking event 714c), the action component 408 can trigger an alarm and render various notifications and on an interactive user dashboard (e.g., interactive user dashboard 700) of a user computing device system (e.g., user computing device system 312) to prompt expedited action with respect to the cybersecurity event. In various embodiments, the action component 408 can also transmit notifications and alerts associated with networking events to one or more user devices (e.g., via email and/or SMS) such that no networking event associated with a cybersecurity event level that satisfies a predefined cybersecurity threat level threshold goes unacknowledged.

In one or more embodiments, the action component 408 can compare one or more asset device instances associated with the edge device(s) 161a-n and the one or more unknown device(s) 310 generated by the network traffic monitoring component 402 to the baseline asset data associated with the network 110. Based on these comparisons, the action component 408 can determine whether the one or more unknown device(s) 310 are trusted devices. Additionally and/or alternatively, the action component 408 can compare the one or more asset device instances to various device lists such as “whitelists” and “blacklists” comprising data related to asset devices that are known to be trusted or untrusted respectively. For example, the action component 408 can determine that edge device(s) 161a-n communicating on the network 110 are trusted devices by comparing the respective asset device instances in the baseline asset data stored in the industrial network data repository system 314. As a result of this comparison, the action component 408 can also determine that unknown device 310 is not a trusted device and has not been approved to communicate on the network 110. In such cases, the action component 408 can, in conjunction with the data storage component 406, automatically update the metadata comprised in the asset device instance associated with the unknown device 310 to mark the state of the unknown device 310 as “pending” and transmit a notification comprising the details of the unknown device 310 communicating on the network 110. In one or more embodiments, the action component 408 can send such a notification regarding the unknown device 310 to a user computing device system 312 as part of the action data 308.

Furthermore, based on comparisons between the asset devices instances generated by the network traffic monitoring component 402 and the baseline asset data, the action component 408 can also determine whether any modifications to the configuration parameters associated with any respective edge device(s) 161a-n devices have been made. The action component 408 can transmit the results of these comparisons as action data 308 to a user computing device system 312 in various ways including, but not limited to, alerts, notifications, alarm triggers, generated networking event reports, and more. Additionally, the action data 308 generated while comparing the network traffic data 304 and the baseline asset data associated with the network 110 can also be rendered on an interactive user dashboard (e.g., interactive user dashboard 700) generated by the industrial network cybersecurity system 302 on the user computing device system 312.

In one or more embodiments, the action component 408 can generate an interactive user dashboard based on the action data 308. In various embodiments, the action data 308 includes one or more visual elements for a visual display (e.g., as rendered by the electronic interface component 508) of the user computing device system 312 that renders the interactive user dashboard (e.g., interactive user dashboard 700) based on a respective configuration of the action data 308. For example, the action component 408 can cause a rendering of visualization data associated with any data related to the network traffic data 304, comparison result data generated by comparing portions of the network traffic data 304 that have been standardized (e.g., standardized asset device instances associated with the devices communicating on the network 110) to the baseline asset data comprised within the industrial network data repository system 314, networking event data, data generated by comparisons made by the action component 408, data to be rendered on the interactive user dashboard, networking event reports, alarms and alerts for networking events satisfying predefined cybersecurity threat level thresholds, notifications regarding networking events, and/or any data associated with the one or more devices communicating on the network 110.

In various embodiments, the rendering of the action data 308 on the interactive user interface (e.g., interactive user dashboard 700) can be caused via one or more computer-executable instructions included in the action data 308. In certain embodiments, the visual display of the user computing device system 312 displays one or more graphical elements associated with the action data 308. In certain embodiments, the electronic interface component 508 of the user computing device system 312 renders one or more interactive display elements associated with the action data 308. In certain embodiments, the action component 408 can configure the electronic interface to render interactive graphs, pie charts, buttons, hyperlinks, tables, and/or the like related to the action data 308.

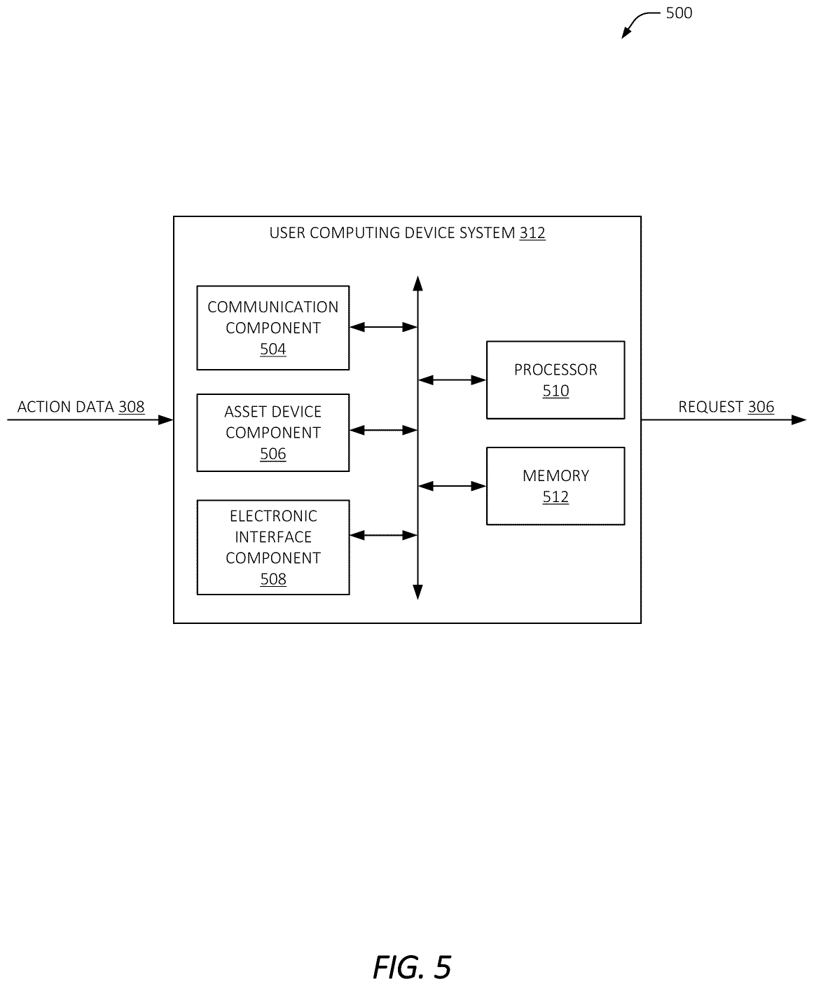

FIG. 5 illustrates a system 500 that provides an exemplary environment according to one or more described features of one or more embodiments of the disclosure. According to an embodiment, the system 500 includes a user computing device system 312 to provide a practical application of mitigating cybersecurity threats for an industrial network. In one or more embodiments, the user computing device system 312 provides a practical application of transmitting requests to generate device lists comprising the asset device instances associated with trusted and untrusted devices communicating on the network 110, execute comparisons of said trusted and untrusted devices to baseline asset data and configurations comprised in an industrial network data repository system, classify one or more networking events occurring on the network 110, mitigate cybersecurity threats associated with the one or more networking events, and/or generate networking event reports detailing the one or more networking events. In one or more embodiments, the user computing device system 312 provides a practical application of receiving and rendering action data (e.g., action data 308) comprising visual representations of said device lists, asset device instances associated with trusted and untrusted devices communicating on the network 110, comparisons of said trusted and untrusted devices to baseline asset data and configurations comprised in the industrial network data repository system, the classifications of the one or more networking events, and/or the networking event reports detailing the networking events.

In an embodiment, the user computing device system 312 facilitates interaction with an industrial network cybersecurity system associated with a data repository system (e.g., industrial network data repository system 314), one or more data sources, and/or one or more assets devices associated with an industrial environment. In one or more embodiments, the user computing device system 312 is a device with one or more processors and a memory. In one or more embodiments, the user computing device system 312 interacts with a computer system from the computer systems 120 to facilitate securing the industrial network to mitigate cybersecurity threats in accordance with various embodiments of the present disclosure. In various embodiments, an interactive user interface is configured via the electronic interface component 508 as a dashboard visualization associated with generating one or more device lists, one or more asset device instances associated with trusted and untrusted devices communicating on the network 110, one or more comparisons of said trusted and untrusted devices to baseline asset data and configurations comprised in an industrial network data repository system, a classification of one or more networking events, and/or one or more networking event reports detailing the one or more networking events occurring on the network 110 associated with a particular industrial environment. In one or more embodiments, the user computing device system 312 interacts with a computer system from the computer systems 120 via the network 110.

Moreover, the user computing device system 312 provides an improvement to one or more technologies such as enterprise technologies, industrial technologies, connected building technologies, IoT technologies, user interface technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, process plant technologies, procurement technologies, and/or one or more other technologies. In an implementation, the user computing device system 312 improves performance of a user computing device. For example, in one or more embodiments, the user computing device system 312 improves processing efficiency of a user computing device, reduces power consumption of a computing device, improves quality of data provided by a user computing device, etc. In various embodiments, the user computing device system 312 improves performance of a user computing device by optimizing content rendered via an interactive user interface, by reducing a number of user interactions with respect to an interactive user interface, and/or by reducing a number of computing resources required to render content via an interactive user interface.

The user computing device system 312 includes a communication component 504, an asset device component 506, and/or an electronic interface component 508. Additionally, in one or more embodiments, the user computing device system 312 includes a processor 510 and/or a memory 512. In certain embodiments, one or more aspects of the user computing device system 312 (and/or other systems, apparatuses and/or processes disclosed herein) constitute executable instructions embodied within a computer-readable storage medium (e.g., the memory 512). For instance, in an embodiment, the memory 512 stores computer executable component and/or executable instructions (e.g., program instructions). Furthermore, the processor 510 facilitates execution of the computer executable components and/or the executable instructions (e.g., the program instructions). In an example embodiment, the processor 510 is configured to execute instructions stored in the memory 512 or otherwise accessible to the processor 510.

The processor 510 is a hardware entity (e.g., physically embodied in circuitry) capable of performing operations according to one or more embodiments of the disclosure. Alternatively, in an embodiment where the processor 510 is embodied as an executor of software instructions, the software instructions configure the processor 510 to perform one or more algorithms and/or operations described herein in response to the software instructions being executed. In an embodiment, the processor 510 is a single core processor, a multi-core processor, multiple processors internal to the user computing device system 312, a remote processor (e.g., a processor implemented on a server), and/or a virtual machine. In certain embodiments, the processor 510 is in communication with the memory 512, the communication component 504, the asset device component 506 and/or the electronic interface component 508 via a bus to, for example, facilitate transmission of data among the processor 510, the memory 512, the communication component 504, the asset device component 506, and/or electronic interface component 508. The processor 510 may be embodied in a number of different ways and, in certain embodiments, includes one or more processing devices configured to perform independently. Additionally or alternatively, in one or more embodiments, the processor 510 includes one or more processors configured in tandem via a bus to enable independent execution of instructions, pipelining of data, and/or multi-thread execution of instructions.

The memory 512 is non-transitory and includes, for example, one or more volatile memories and/or one or more non-volatile memories. In other words, in one or more embodiments, the memory 512 is an electronic storage device (e.g., a computer-readable storage medium). The memory 512 is configured to store information, data, content, one or more applications, one or more instructions, or the like, to enable the user computing device system 312 to carry out various functions in accordance with one or more embodiments disclosed herein. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor, circuitry, an executable component, a thread of instructions, a program, and/or a computer entity.

In one or more embodiments, the communication component 504 is configured to generate the request 306. In various embodiments, the request 306 is a request to update and/or modify the configuration parameters associated with edge devices 161a-n, a request to poll any asset devices communicating on the network 110 for identifying information, a request to create, update, and/or remove an asset device instance associated with an asset device communicating on the network 110, a request to create, update, and/or remove a networking event rule, a request to generate a networking event report (e.g., networking event report 710), a request to export and/or transmit at least of portion of the data rendered on an interactive user dashboard (e.g., interactive user dashboard 700), a request to approve an asset device for communicating on the industrial network, a request to decommission an asset device in the industrial network, and/or a request to start or stop collecting network traffic data 304 from the network 110.

In various embodiments, the communication component 504 generates the request 306 in response to an action performed with respect to a user interface configuration for an interactive user interface rendered on a visual display via the electronic interface component 508. The action can be, for example, initiating execution of an application (e.g., a mobile application) via a user computing device that presents the interactive user interface, altering an interactive graphical element via the interactive user interface, or another type of action with respect to the interactive user interface rendered via the electronic interface component 508. Additionally or alternatively, in one or more embodiments, the communication component 504 generates the request 306 in response to execution of a user authentication process via a user computing device. For example, in an embodiment, the user authentication process is associated with password entry, facial recognition, biometric recognition, security key exchange, and/or another security technique associated with a user computing device.

In various embodiments, the interactive user interface is a dashboard visualization (e.g., interactive user dashboard 700) related to securing an industrial network to mitigate cybersecurity threats to one or more industrial assets related to one or more industrial processes in an industrial environment. In various embodiments, the one or more industrial processes are related to the edge devices 161a-161n (e.g., the edge devices 161a-161n included in a portfolio of assets). In one or more embodiments, the edge devices 161a-161n are associated with the portfolio of assets. For instance, in one or more embodiments, the edge devices 161a-161n include one or more assets in a portfolio of assets. The edge devices 161a-161n include, in one or more embodiments, one or more databases, one or more assets (e.g., one or more building assets, one or more industrial assets, etc.), one or more IoT devices (e.g., one or more industrial IoT devices), one or more connected building assets, one or more sensors, one or more actuators, one or more processors, one or more computers, one or more valves, one or more pumps (e.g., one or more centrifugal pumps, etc.), one or more motors, one or more compressors, one or more turbines, one or more ducts, one or more heaters, one or more chillers, one or more coolers, one or more boilers, one or more furnaces, one or more heat exchangers, one or more fans, one or more blowers, one or more conveyor belts, one or more vehicle components, one or more cameras, one or more displays, one or more security components, one or more air handler units, one or more HVAC components, industrial equipment, factory equipment, and/or one or more other devices that are connected to the network 110 for collecting, sending, and/or receiving information. In one or more embodiments, the edge device 161a-161n include, or is otherwise in communication with, one or more controllers for selectively controlling a respective edge device 161a-161n and/or for sending/receiving information between the edge devices 161a-161n and an industrial network cybersecurity system via the network 110. In one or more embodiments, the edge devices 161a-161n are associated with an industrial environment (e.g., a plant, etc.). Additionally or alternatively, in one or more embodiments, the edge devices 161a-161n are associated with components of the edge 115 such as, for example, one or more enterprises 160a-160n.

In one or more embodiments, the request 306 includes a reference to one or more asset device instances that describe one or more respective physical industrial assets in the industrial environment associated with the industrial network. For instance, in one or more embodiments, the request 306 includes a reference to one or more asset device instances associated with the edge devices 161a-161n in order to update and/or modify the configuration parameters associated with the edge devices 161a-n. In one or more embodiments, the asset device instances comprise metadata related to, but not limited by, asset device identifiers, MAC addresses, IP addresses, hostnames, vendor names, operating system identifiers, data related to networking protocols being employed by the asset devices (e.g., TCP and/or UDP), device status (e.g., “pending,” or “under investigation”), as well as historical log data such as timestamp data, identifiers corresponding to various networking devices (e.g., networking switch and/or router addresses) used by the asset device during transmission, port numbers used, and/or other descriptions.

In various embodiments, the communication component 504 is configured to transmit the request 306. In one or more embodiments, the communication component 504 transmits the request 306 to an industrial network cybersecurity system (e.g., industrial network cybersecurity system 302). In one or more embodiments, the communication component 504 transmits the request 306 to a data repository system (e.g., industrial network data repository system 314). In various embodiments, the communication component 504 transmits the request 306 to a computer system from the computer systems 120 to facilitate altering configuration of the interactive user interface. In one or more embodiments, the communication component 504 transmits the request 306 via the network 110.

In one or more embodiments, in response to the request 306, the communication component 504 and/or the asset device component 506 is configured to receive action data 308. In one or more embodiments, the asset device component 506 receives the action data 308 from the data repository system. For example, in one or more embodiments, the asset device component 506 receives the action data 308 from an industrial network cybersecurity system (e.g., industrial network cybersecurity system 302). In one or more embodiments, the asset device component 506 receives the action data 308 from a computer system from the computer systems 120 to facilitate altering configuration of the interactive user dashboard based on the action data 308. In one or more embodiments, the communication component 504 and/or the asset device component 506 receives the action data 308 via the network 110. In certain embodiments, the communication component 504 and/or the asset device component 506 incorporates encryption capabilities to facilitate encryption and/or decryption of one or more portions of the action data 308. Additionally, the asset device component 506 can work in conjunction with the electronic interface component 508 to render the action data 308 on an interactive user dashboard (e.g., interactive user dashboard 700).

In one or more embodiments, the action data 308 is configured based on one or more asset device instances associated with one or more trusted asset devices, one or more asset device instances associated with one or more untrusted devices, and/or one or more asset device instances associated with one or more unknown devices communicating on the network 110. Additionally, in one or more embodiments, the action data 308 is configured based on one or more networking events currently occurring on the network 110, one or more networking events that occurred on the network 110 in the past, and/or historical log data associated with one or more asset devices communicating on the network 110. Additionally, in one or more embodiments, the action data 308 is configured based on notifications and/or alarms associated with networking events with cybersecurity event levels that satisfy predefined cybersecurity threat level thresholds (e.g., networking events associated with a cybersecurity event level of “critical”). In one or more embodiments, the communication component 504 and/or the asset device component 506 is configured to interface with a data repository system (e.g., the industrial network data repository system 314) to facilitate receiving the action data 308.

In one or more embodiments, the asset device component 506, in conjunction with the electronic interface component 508, is configured to render a networking event report detailing one or more networking events that occurred on the network 110 based on the action data 308 on an interactive user interface. In one or more embodiments, the interactive user interface is configured as a dashboard visualization (e.g., interactive user dashboard 700) rendered via a display of a user computing device. In one or more embodiments, the interactive user dashboard is configured to provide prioritized actions related to the networking event report. Such prioritized actions can include, but are not limited to, updating the status of an asset device communicating on the network 110. For example, based on an interaction with the interactive user dashboard, the status of a particular asset device can be changed from “pending” to “approved,” where changing the status of the asset device to “approved” can generate a request 306 to update the asset device instance associated with the particular asset device in the industrial network data repository system 314.

In one or more embodiments, the electronic interface component 508 renders the action data 308 as respective interactive display elements on an interactive user interface. An interactive display element is a portion of the interactive user interface (e.g., a user-interactive electronic interface portion) that provides interaction with respect to a user of the user computing device. For example, in one or more embodiments, an interactive display element is an interactive display element associated with a set of pixels that allows a user to provide feedback and/or to perform one or more actions with respect to the interactive user interface. In an embodiment, in response to interaction with an interactive display element, the interactive user interface is dynamically altered to display one or more altered portions of the interactive user interface associated with different visual data and/or different interactive display elements.

Additionally, in one or more embodiments, the electronic interface component 508 is configured to facilitate execution and/or initiation of one or more actions via an interactive user dashboard configured based on the action data 308. In an embodiment, an action is executed and/or initiated via an interactive display element of the interactive user dashboard. In certain embodiments, the interactive user interface presents one or more notifications associated with the prioritized actions related to a networking event report compiled from the action data 308. In certain embodiments, an action related to an interactive display element of the interactive user dashboard includes an action associated with the application services layer 225, the applications layer 230, and/or the core services layer 235.

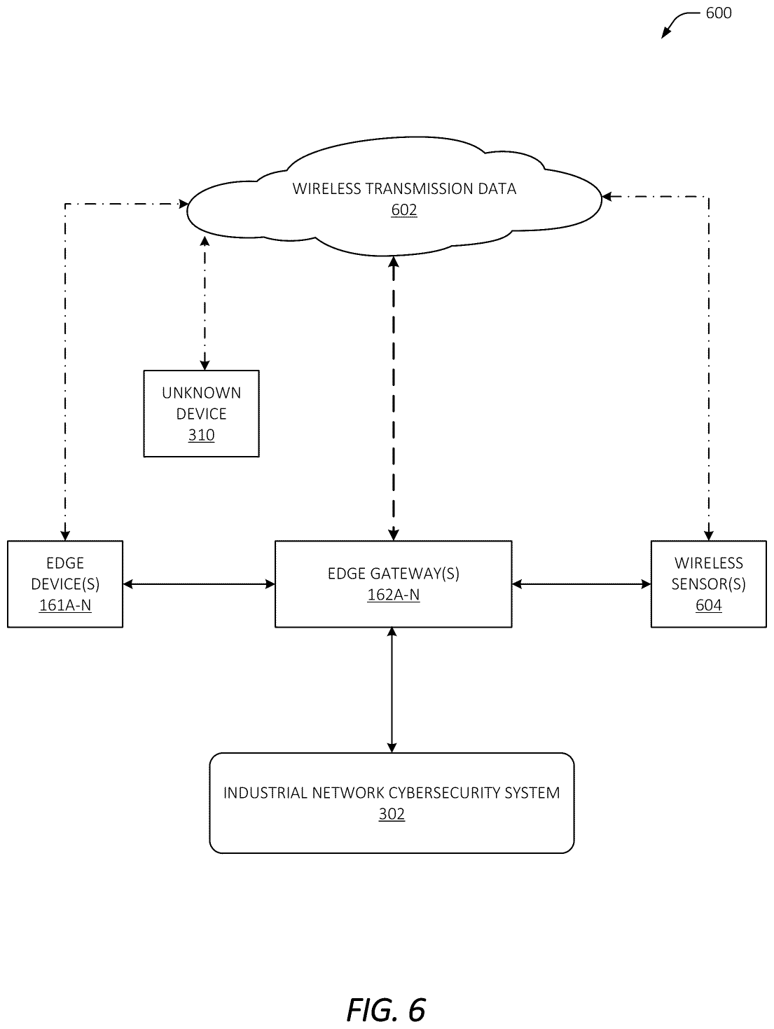

FIG. 6 illustrates an exemplary environment 600 related to collecting network traffic data related to radio frequency signals transmitted by one or more wireless devices communicating in an industrial networking environment, in accordance with one or more embodiments described herein. Specifically, FIG. 6 illustrates how one or more embodiments of the present disclosure can collect wireless transmission data via wireless sensors communicatively coupled to an access gateway associated with an industrial network. For example, one or more wireless sensor(s) 604 can be communicatively coupled to one or more respective edge gateway(s) 162a-n, where the wireless sensor(s) 604 are employed to capture wireless transmission data 602. According to various embodiments, the edge devices 161a-n represent any of a variety of different types of devices that may be found within the enterprises 160a-n. In one or more embodiments, the edge gateways 162a-n include devices for facilitating communication between the edge devices 161a-n and the cloud 105 via network 110. For example, the edge gateways 162a-n include one or more communication interfaces for communicating with the edge devices 161a-n and for communicating with the cloud 105 via network 110.

In one or more embodiments, the edge gateways 162a-n are employed in a level-three (L3) industrial network layer. The L3 industrial network layer can be a process and control layer of a four-layer industrial networking topology. Likewise, in one or more embodiments, the industrial network cybersecurity system 302 is also employed in the L3 industrial network layer. In one or more embodiments, the industrial network cybersecurity system 302 can be integrated into the L3 industrial network layer to monitor communication between wireless networking devices and/or wired networking devices. The L3 network layer can also be configured to manage wireless devices are capable of interfacing with the industrial network through various access gateways.

In one or more embodiments, wireless transmission data 602 makes up at least a portion of network traffic data 304. In various embodiments, wireless transmission data 602 can comprise any wireless communication signals transmitted by one or more wireless asset devices capable of interfacing with the industrial network via wireless networking protocols such as WiFi. For example, wireless transmission data 602 can comprise any wireless transmission data transmitted by edge device(s) 161a-n and/or one or more unknown device(s) 310 via WiFi protocols including, but not limited to, 802.11a, 802.11b, 802.11g, 802.11n, 802.11ac, and/or 802.11ax. Additionally, wireless transmission data 602 can comprise any wireless communications made to one or more edge device(s) 161a-n and/or one or more edge gateway(s) 162a-n using various radio frequency signals, nearfield communication protocols, and/or other wireless communication protocols such as Bluetooth, ZigBee, Z-Wave, and/or the like.

In one or more embodiments, the wireless sensor(s) 604 are configured to extract network traffic data directly from the wireless transmission data 602. The industrial network cybersecurity system 302 can then process the wireless transmission data 602 in order to secure the industrial network and mitigate any cybersecurity threats. Because the wireless sensor(s) 604 are configured to extract network traffic data associated from one or more wireless devices communicating in the industrial environment directly from the wireless transmission data 602, the wireless sensor(s) 604 provide the added benefit of allowing the industrial network cybersecurity system 302 to process said network traffic data without having to interface with additional networking equipment such as wireless routers, hotspots, switches, network bridges and/or the like. This adds the technical benefit of allowing the industrial network cybersecurity system 302 to begin processing the network traffic data extracted from the wireless transmission data 602 immediately, thus saving time and resources and allowing the industrial network cybersecurity system 302 to quickly mitigate cybersecurity threats to the industrial network.

FIG. 7 illustrates an exemplary interactive user dashboard 700, in accordance with one or more embodiments described herein. In one or more embodiments, the industrial network cybersecurity system 302 can render data related to the baseline asset data, the number of devices communicating on the industrial network, the ratio of trusted to untrusted devices, graphs representing networking event frequencies, and/or tables detailing the one or more networking events occurring on the industrial network on the interactive user dashboard 700. In one or more embodiments, the interactive user dashboard 700 comprises interactive display elements 702-708, networking event report 710, interactive networking event table 712, and/or networking events 714a-n. In one or more embodiments, the interactive user dashboard can be rendered on an interactive user interface of a user computing device system (e.g., user computing device system 312) as a configuration of visualization data associated with action data 308. In various embodiments, the interactive user dashboard is generated by the action component 408 of the industrial network cybersecurity system 302 and transmitted to the user computing device system 312 to be rendered by the asset device component 506 and/or the electronic interface component 508 on an interactive user interface associated with the user computing device system 312. In one or more embodiments, the interactive user dashboard 700 can be cloud-based such that the interactive user dashboard 700 can be rendered via a web browser associated with the user computing device system 312 from a location that is remote from the industrial network.

Various portions of visualization data associated with the action data 308 can be configured as interactive display elements on the interactive user dashboard 700. An interactive display element is a portion of the interactive user dashboard (e.g., a user-interactive electronic interface portion) that provides interaction with respect to a user of the user computing device. For example, in one or more embodiments, an interactive display element is an interactive display element associated with a set of pixels that allows a user to provide feedback and/or to perform one or more actions with respect to the interactive user interface. In an embodiment, in response to interaction with an interactive display element, the interactive user interface is dynamically altered to display one or more altered portions of the interactive user interface associated with different visual data and/or different interactive display elements.

In various embodiments, one or more interactive display elements associated with the action data 308 can be configured as interactive graphs, interactive pie charts, interactive buttons, interactive icons, interactive hyperlinks, interactive tables, and/or the like related to the action data 308 generated by the industrial network cybersecurity system 302. For example, in one or more embodiments, the interactive display element 702 is configured as an interactive text block that can, upon user engagement, display in-depth details related to, but not limited by, identifying information associated with an industrial enterprise (e.g., enterprise name and logo, industrial site name and region, and/or the like) as well as ratios and percentages of the one or more asset devices communicating on an industrial network associated with a particular industrial site associate with the industrial enterprise. As another example, in some embodiments, interactive display element 704 can be configured as an interactive icon representing an export action associated with various portions of the action data 308 related to a particular industrial network being rendered on the interactive user dashboard 700. For instance, a user engagement with the interactive display element 704 can generate a networking event report 710 comprising a summary of the action data 308 being rendered on the interactive user dashboard 700. Additionally and/or alternatively, in various embodiments, a user engagement with the interactive display element 704 can cause an export of only a portion of the action data 308 associated with that particular interactive display element 704, such as, for example, a portion of the action data 308 related to interactive display element 708 which is configured as an interactive graph representing data related to the new asset devices versus approved asset devices associated with the industrial network.

In one or more embodiments, networking event report 710 and/or various summaries related to the action data 308 can be generated based on the data being rendered on the interactive user dashboard 700 and can be exported from the industrial network cybersecurity system 302 in various formats. In various embodiments, one or more networking event report(s) 710 and/or summaries associated with various portions of the action data 308 can be automatically generated based on a predefined schedule (e.g., daily, weekly, bi-weekly, monthly, etc.) and transmitted to one or more user devices in various ways, such as, for example, via email. Additionally and/or alternatively, the networking event report 710 and/or summaries associated with various portions of the action data 308 can be generated manually via an interaction with one or more respective interactive display elements (e.g., interactive display element 704) and transmitted to a user device.

In one or more embodiments, interactive display element 706 can be configured as an interactive pie chart related to the ratio of trusted asset devices associated with networking events classified with various respective cybersecurity event levels. In one or more embodiments, a user selection of the interactive display element 706 configured as an interactive pie chart can cause the interactive user dashboard 700 to be reconfigured. For example, a user selection of the interactive display element 706 can cause generation of interactive networking event table 712. In one or more embodiments, the interactive networking event table 712 comprises data related to one or more networking events 714a-n that occurred on the network 110. In various embodiments, the interactive networking event table 712 can comprise networking event data related to networking events 714a-n including, but not limited to, a networking event type, an asset device identifier, an asset device address, a cybersecurity event level, a networking event description, networking event timestamp information, a networking event status, and/or a responsible administrator identifier.

In one or more embodiments, the action data 308 can be rendered on the interactive user dashboard 700 in real time. For example, the interactive user dashboard 700 can display data associated with network traffic data 304 as the network traffic data 304 is being collected and processed by the industrial network cybersecurity system 302. Additionally and/or alternatively, the interactive user dashboard 700 can be configured to display portions of the action data 308 corresponding to a specific range of time, such as, for example, portions of the action data 308 corresponding to a particular hour, day, week, month, year, and/or the like.

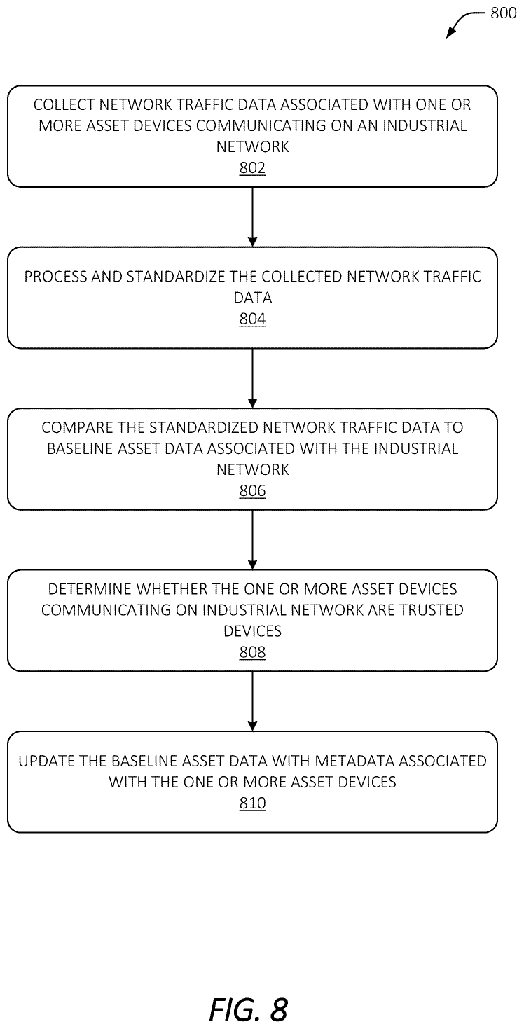

FIG. 8 illustrates a process flow diagram for collecting network traffic data in order to classify one or more devices communicating on an industrial network, in accordance with one or more embodiments described herein. Specifically, FIG. 8 illustrates a method 800 for mitigating cybersecurity threats for an industrial network. In one or more embodiments, the method 800 is associated with the industrial network cybersecurity system 302. Additionally or alternatively, in various embodiments, the method 800 is associated with the user computing device system 312 in conjunction with the industrial network cybersecurity system 302. In one or more embodiments, the method 800 begins at step 802 that collects network traffic data (e.g., network traffic data 304) associated with one or more asset devices communicating on an industrial network. In one or more embodiments, industrial network cybersecurity system 302 repeatedly monitors an industrial network (e.g., network 110) and collects network traffic data (e.g., network traffic data 304). In various embodiments, the network traffic data 304 is raw network traffic data related to all of the devices communicating on the network 110 such as, for example, edge device(s) 161a-n, unknown device 310, and/or user computing device system 312. In various embodiments, the network traffic data 304 comprises metadata related to each of the one or more devices communicating on the network 110 including, but not limited to, the type of device (wired or wireless), the model and/or vendor of the device, address information (e.g., IP and/or MAC address data), networking protocols, data transmission timestamp information, and/or various configuration parameters associated with the device. As the industrial network cybersecurity system 302 repeatedly collects the network traffic data 304, the industrial network cybersecurity system 302 can store the network traffic data 304 in a repository comprised in the industrial network data repository system 314.

The method 800 also includes a step 804 in which the industrial network cybersecurity system 302 processes and standardizes the collected network traffic data into a structured digital format. For example, the industrial network cybersecurity system 302 generates asset device instances for each device communicating on the network 110, where the asset device instances can be electronically managed data objects containing structured metadata related to the devices communicating on the industrial network. In one or more embodiments, the asset device instances comprise metadata related to, but not limited by, asset device identifiers, MAC addresses, IP addresses, hostnames, vendor names, operating system identifiers, data related to networking protocols being employed by the asset devices (e.g., TCP and/or UDP), device status (e.g., “pending,” or “under investigation”), as well as historical log data such as timestamp data, identifiers corresponding to various networking devices (e.g., networking switch and/or router addresses) used by the asset device during transmission, port numbers used, and/or other descriptions. In one or more embodiments, the industrial network cybersecurity system 302 compiles one or more device lists comprising the one or more asset device instances associated with the edge devices 161a-n and the one or more unknown device(s) 310 communicating on the network 110.

The method 800 also includes a step 806 in which the industrial network cybersecurity system 302 compares the standardized network traffic data to the baseline asset data associated with the industrial network. For example, the industrial network cybersecurity system 302 can compare the asset device instances associated with the edge device(s) 161a-n, as well as the asset device instances associated with the one or more unknown device(s) 310, to the baseline asset data stored in the industrial network data repository system 314. In one or more embodiments, an industrial network data repository system 314 comprising one or more asset device databases contains baseline asset data related to the trusted devices that have been approved to communicate on the industrial network. In various embodiments, the baseline asset data comprises one or more asset device instances associated with one or more respective trusted devices associated with the industrial network, where the asset device instances can be electronically managed data objects containing structured metadata related to the trusted devices in the industrial network. In one or more embodiments, the asset device instances comprise metadata related to, but not limited by, asset device identifiers, MAC addresses, IP addresses, hostnames, vendor names, operating system identifiers, data related to networking protocols being employed by the asset devices (e.g., TCP and/or UDP), device status (e.g., “pending,” or “under investigation”), as well as historical log data such as timestamp data, identifiers corresponding to various networking devices (e.g., networking switch and/or router addresses) used by the asset device during transmission, port numbers used, and/or other descriptions. The asset device instances in the baseline asset data also comprise various configuration parameters related to the trusted devices that dictate various operating configurations associated with each respective asset device.

The method 800 also includes a step 808 in which the industrial network cybersecurity system 302 determines whether the one or more asset devices communicating on the industrial network are trusted devices. Based on the comparison between the one or more device lists comprising the asset device instances associated with the asset devices communicating on the industrial network and the baseline asset data, the industrial network cybersecurity system 302 can determine whether the one or more unknown device(s) 310 are trusted devices. In various embodiments, the industrial network cybersecurity system 302 determines that the asset devices communicating on the industrial network are associated with asset device instances on a whitelist comprised in the baseline asset data. In one or more embodiments, the whitelist is associated with an industrial enterprise related to the industrial network. The industrial enterprise may distribute the asset device whitelist to a user device to facilitate monitoring respective industrial networks at various industrial environments so that field workers operating whitelisted IoT devices in multiple industrial networks won't trigger any alarms when connecting the whitelisted IoT devices to a particular industrial network. In some embodiments, the industrial network cybersecurity system 302 can authenticate a new, unknown device (e.g., unknown device 310) communicating on the industrial network and update the metadata in a corresponding asset device instance associated with the device in the industrial network data repository system 314.

The method 800 also includes a step 810 in which the industrial network cybersecurity system 302 updates the baseline asset data with metadata associated with the one or more asset devices. In one or more embodiments, when a new asset device has been approved by the industrial network cybersecurity system 302 and employed on the industrial network, the baseline asset data associated with the industrial network is updated to include the asset device instance and metadata associated with the newly trusted device. In some embodiments, if an unknown device (e.g., unknown device 310) communicating on the industrial network is identified as a whitelisted device, the industrial network cybersecurity system 302 can automatically approve the unknown device into the industrial network such that the unknown device is allowed to communicate on the industrial network and can update the baseline asset data in the asset device sever system to include metadata with the unknown device.

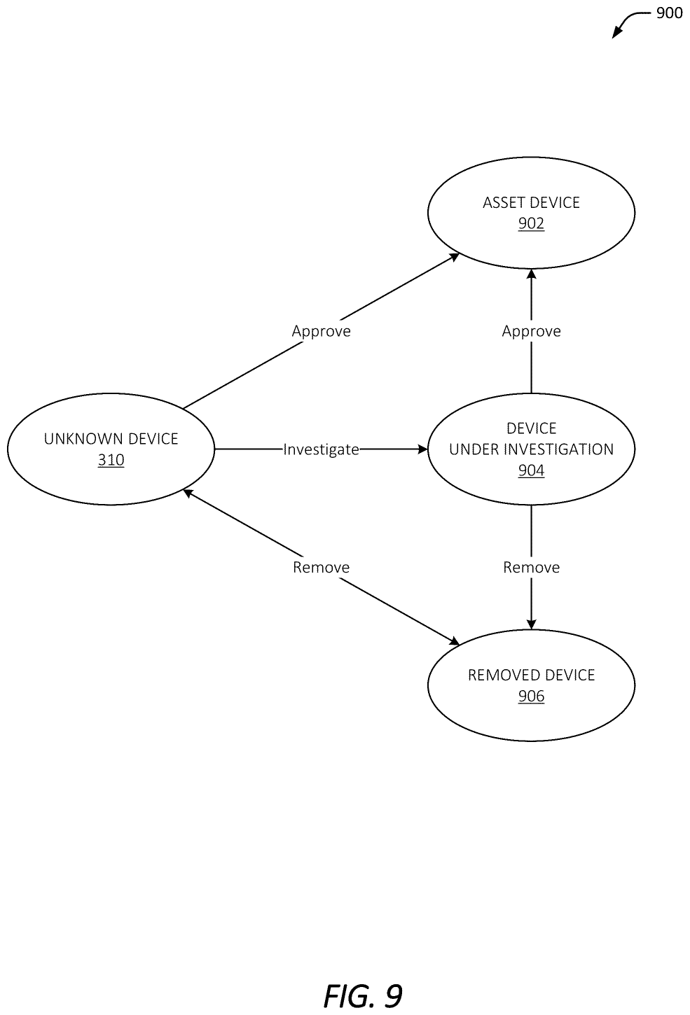

FIG. 9 illustrates a data flow diagram for classifying the status of one or more devices communicating on an industrial network, in accordance with one or more embodiments described herein. Specifically, FIG. 9 illustrates a method 900 for classifying and/or updating the status associated with a device communicating on an industrial network. In one or more embodiments, the method 900 is associated with the industrial network cybersecurity system 302. Additionally or alternatively, in various embodiments, the method 900 is associated with the user computing device system 312 in conjunction with the industrial network cybersecurity system 302.

In various embodiments, the industrial network cybersecurity system 302 can employ one or more node detection techniques to classify devices communicating on the industrial network as trusted or untrusted devices. In one or more embodiments, the industrial network cybersecurity system 302 automatically classifies the status of new, unknown nodes, or unknown devices (e.g., unknown device 310), communicating on the industrial network as “pending,” and updates metadata related to the status of the unknown device in an asset device instance associated with the unknown device. Various statuses can be attributed to the asset devices communicating on the industrial network including, but not limited to, “pending,” “approved,” “under investigation,” and “removed” by updating the metadata of an asset device instance corresponding to the respective asset devices. In various embodiments, the status of any device communicating on the industrial network can be updated via the interactive user dashboard 700 generated by the industrial network cybersecurity system 302, thereby determining which devices are “trusted” and allowed to communicate on the industrial network. For example, a request 306 can be generated via an interaction with one or more interactive display elements (e.g., interactive display element(s) 702-708) on the interactive user dashboard 700, where the request 306 is a request to update the status of one or more devices communicating on the industrial network. In one or more embodiments, any time an update is made to an asset device instance associated with an asset device, the baseline asset data associated with the industrial network is automatically updated as well.

In various embodiments, the industrial network cybersecurity system 302 can determine that unknown device 310 is not a known, trusted device and has not been approved to communicate on the network 110. In such cases, the industrial network cybersecurity system 302 can automatically update the metadata comprised in the asset device instance associated with the unknown device 310 to mark the state of the unknown device 310 as “pending” and transmit a notification comprising the details of the unknown device 310 communicating on the network 110. In one or more embodiments, the industrial network cybersecurity system 302 can send such a notification regarding the unknown device 310 to a user computing device system as part of the action data 308. Alternatively, the industrial network cybersecurity system 302 can determine that metadata related to the unknown device 310 matches data comprised on an asset device whitelist, and/or a mapping of network switches and/or network ports, and automatically update the status of the unknown device 310 to “approved,” effectively converting the unknown device 310 into asset device 902.

In one or more embodiments, the status of an asset device such as an unknown device 310, asset device 902, device under investigation 904, and/or removed device 906 can be manually updated. For example, an unknown device 310 that is communicating on the network 110 can be “approved,” thereby converting the unknown device 310 into asset device 902. Likewise, an unknown device 310 that is executing suspicious activity on the network 110 can be flagged as being “under investigation,” thereby converting the unknown device 310 into the device under investigation 904. Similarly, the device under investigation 904 can be converted by the industrial network cybersecurity system 302 into an asset device 902 by approving the device under investigation 904, or, alternatively, the device under investigation 904 can be converted into the removed device 906. Such conversions can be executed based on interactions with the interactive user dashboard 700 generated by the industrial network cybersecurity system 302. In one or more embodiments, once an asset device is converted into a removed device 906, (e.g., the metadata in the asset device instance associated with the respective asset device is updated) the removed device 906 can be automatically removed from view on the interactive user dashboard 700. Additionally and/or alternatively, in various embodiments, if a removed device 906 communicates on the network 110 again in the future, the removed device 906 will be converted back into an unknown device 310, and, as such, the status associated with the unknown device 310 will be updated to “pending” once again by the industrial network cybersecurity system 302.

In some embodiments, the industrial network cybersecurity system 302 can generate a mapping of network switches and/or network ports based on the one or more approved asset devices associated with the industrial network. One or more nodes associated with respective approved asset devices can be generated, where the one or more nodes is an electronically managed data object comprising metadata associated with a respective asset device. In various embodiments, the metadata comprised in the one or more nodes can be related to, but is not limited by, node identifiers, asset device identifiers, MAC addresses, IP addresses, hostnames, vendor names, operating system identifiers, data related to networking protocols being employed by the asset devices (e.g., TCP and/or UDP), device status (e.g., “pending,” or “under investigation”), as well as historical log data such as timestamp data, identifiers corresponding to various networking devices (e.g., networking switch and/or router addresses) used by the asset device during transmission, port numbers used, and/or other descriptions.

In various embodiments, the mapping of network switches and/or network ports can be a configuration of visually interconnected interactive display elements associated with the one or more nodes and rendered on the interactive user dashboard 700. Additionally and/or alternatively, the mapping of network switches and/or network ports can be configured as a list of interactive display elements describing the one or more nodes and rendered on the interactive user dashboard 700. In various embodiments, when a node associated with an approved asset device is generated, the node is automatically added to the mapping of network switches and/or network ports and metadata associated with the node is updated and stored in the industrial network data repository system 314. Likewise, in various embodiments, when a newly approved asset device communicating on the industrial network is authenticated, a node associated with the newly approved asset device is generated and the mapping of network switches and/or network ports is automatically updated to include the node.

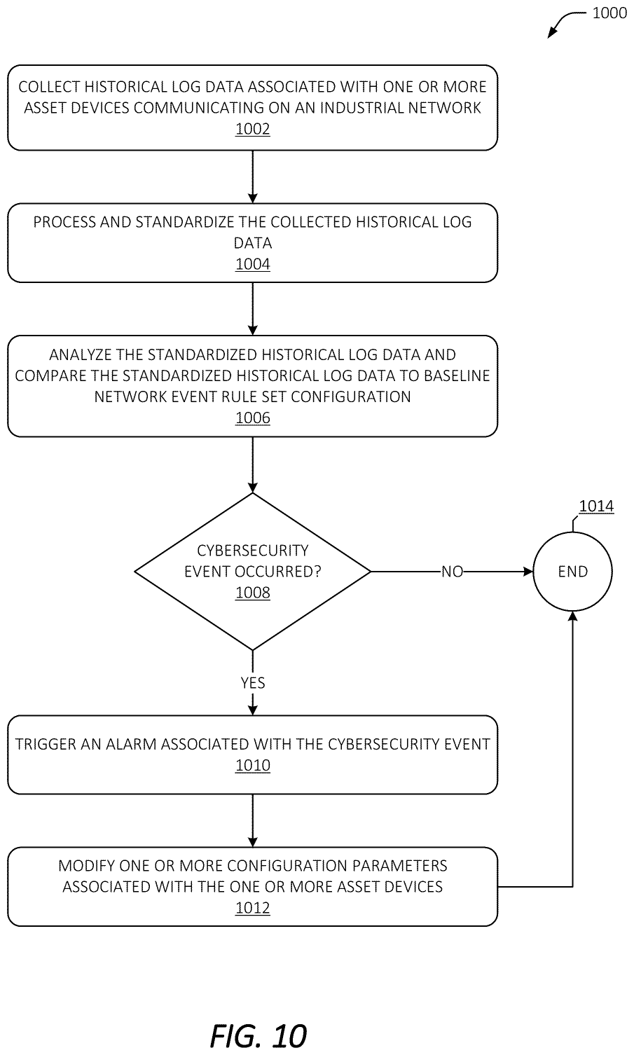

FIG. 10 illustrates a process flow diagram for analyzing historical log data to mitigate cybersecurity threats, in accordance with one or more embodiments described herein. Specifically, FIG. 10 illustrates a method 1000 for mitigating cybersecurity threats for an industrial network by determining whether a cybersecurity event has occurred on the industrial network based on the collected historical log data associated with the asset devices communicating on the industrial network. In one or more embodiments, the method 1000 is associated with the industrial network cybersecurity system 302. Additionally or alternatively, in various embodiments, the method 1000 is associated with the user computing device system 312 in conjunction with the industrial network cybersecurity system 302. In one or more embodiments, the method 1000 begins at step 1002 in which the industrial network cybersecurity system 302 collects historical log data associated with one or more asset devices (e.g., edge devices 161a-n and/or one or more unknown device(s) 310) communicating on an industrial network. In various embodiments, the historical log data contains metadata including, but not limited to, timestamp data, identifiers corresponding to various networking devices (e.g., networking switch and/or router addresses) used by the one or more asset devices during data transmission, port numbers associated with various networking devices used by the one or more asset devices, and/or other descriptions associated with the one or more asset devices. The industrial network cybersecurity system 302 can also use historical log data associated with said asset device instance to identify which other devices the unknown device 310 has communicated with and which networking devices (e.g., switches, routers) the unknown device 310 used to transmit data. The industrial network cybersecurity system 302 also captures the same information from approved devices (e.g., edge device(s) 161a-n) as the approved devices communicate on the network 110. In various embodiments, at least a portion of the historical log data collected by the industrial network cybersecurity system 302 is extracted from the network traffic data 304.

The method 1000 also includes a step 1004 in which the industrial network cybersecurity system 302 processes and standardizes the collected historical log data. In one or more embodiments, the historical log data associated with the one or more asset devices can be used to generate one or more networking events, where the one or more networking events can be electronically managed data objects comprising a networking event feature set corresponding to any metadata related to the associated one or more asset devices and any information related to the networking event itself. Once the historical log data has been processed, the industrial network cybersecurity system 302 can associate the historical log data with the respective asset device instances associated with the edge device(s) 161a-n and the one or more unknown device(s) 310 and update the respective asset device instances in the industrial network data repository system 314. In various embodiments, historical log data associated with a particular asset device can be updated in response to an interaction with an interactive user dashboard rendered by the industrial network cybersecurity system 302 (e.g., interactive user dashboard 700). For example, based on an interaction with the interactive user dashboard 700, a request 306 can be transmitted to the industrial network cybersecurity system 302 to update, via the network traffic monitoring component 402, the metadata associated with the description for a particular asset device instance. In one or more embodiments, the processed and standardized historical log data can be stored in the industrial network data repository system 314.

The method 1000 also includes a step 1006 in which the industrial network cybersecurity system 302 analyzes the standardized historical log data and compares the standardized historical log data to a baseline network event rule set configuration. In one or more embodiments, the industrial network cybersecurity system 302 includes a cybersecurity event component 404 comprising a plurality of networking event rules and configurations detailing how asset devices may communicate on the network 110 and which networking events will trigger an alarm. The industrial network cybersecurity system 302 can employ the cybersecurity event component 404 to compare the historical log data to the baseline network event rule set configuration as well as baseline asset data associated with the network 110. In one or more embodiments, the plurality of network event rules comprised in the cybersecurity event component 404 can be configured by a user computing device system 312 associated with the industrial network. In various embodiments the user computing device system 312 can configure one or more networking event rules associated with one or more respective cybersecurity event levels. Cybersecurity event levels can include, but are not limited to, “critical,” “high,” “moderate,” and “informational.” Additionally, in some embodiments, networking events of varying severity can also be assigned to respective categories classifying the type of networking event. For instance, a rule pertaining to unusual activity being performed by edge device(s) 161a-n on the network 110 can be defined as a “security event” with a cybersecurity event level of “critical,” whereas a rule pertaining to an administrative change made to a group policy via the user computing device system 312 can be defined as a “Windows event” with a cybersecurity event level of “high.” Additionally and/or alternatively, in various embodiments, one or more of the plurality of rules comprised in the cybersecurity event component 404 of the industrial network cybersecurity system 302 can reflect international cybersecurity standards for industrial networks (e.g., ISA/IEC 62443) and respective cybersecurity event levels can be attributed to the networking event rules associated with the international standards.

The method 1000 also includes a step 1008 in which the industrial network cybersecurity system 302 determines, based on the historical log data analysis, whether a cybersecurity event has occurred. If the industrial network cybersecurity system 302 determines that no cybersecurity events have occurred, the method 1000 proceeds to step 1014 in which the process is ended. However, if the industrial network cybersecurity system 302 determines that a cybersecurity event has indeed occurred, the method 1000 will proceed to step 1010. For example, when the industrial network cybersecurity system 302 detects a networking event that exceeds a predefined cybersecurity threat level threshold (e.g., networking events with a “high” or “critical” cybersecurity event level), certain automatic actions can then be executed. In the event that a networking event associated with a high or critical cybersecurity event level occurs, the industrial network cybersecurity system 302 can trigger one or more alarms and/or executed one or more automatic cybersecurity threat mitigation actions.

At step 1010, the industrial network cybersecurity system 302 triggers an alarm associated with the cybersecurity event. For example, if a networking event has a cybersecurity event level of high or critical (e.g., networking event 714c), the industrial network cybersecurity system 302 can trigger an alarm and render various notifications and on an interactive user dashboard (e.g., interactive user dashboard 700) of a user computing device system (e.g., user computing device system 312) to prompt expedited action with respect to the cybersecurity event. In various embodiments, the industrial network cybersecurity system 302 can also transmit notifications and alerts associated with networking events to one or more user devices (e.g., via email and/or SMS) such that no networking event associated with a cybersecurity event level that satisfies a predefined cybersecurity threat level threshold goes unacknowledged.

The method 1000 also includes a step 1012 in which the industrial network cybersecurity system 302 modifies one or more configuration parameters associated with the one or more asset devices associated with the cybersecurity event. In one or more embodiments, the industrial network cybersecurity system 302 can execute automatic cybersecurity threat mitigation actions to mitigate cybersecurity threats as the cybersecurity threats are detected. Such cybersecurity threat mitigation techniques can stop an adverse networking event quickly without the need for manual intervention, thus mitigating the cybersecurity threat and/or improving performance of an industrial network. For example, if the industrial network cybersecurity system 302 detects a networking event associated with a cybersecurity event level categorized as “critical” such as, for example, detecting unusual activity on the network 110 from an asset device (e.g., edge device 161a) with privileged user access permissions, the industrial network cybersecurity system 302 can temporarily decommission the associated asset device such that the associated asset device can make no further communications on the network 110 until the networking event can be reviewed. Likewise, if an unauthorized “insider” (e.g., a user employed by the industrial enterprise) is repeatedly attempting to access a secure part of the industrial network (e.g., the industrial network data repository system 314) from a particular asset device (e.g., edge device 161a), the industrial network cybersecurity system 302 can automatically decommission the asset device, flag the user account in question, and/or transmit an alert to a user device with the details of the networking event. In one or more embodiments, decommissioning an asset device (e.g., edge device 161a-n) can include at least one of, but is not limited to, de-powering or putting the device into a stand-by mode, modifying one or more configuration parameters associated with the asset device, changing user access permissions associated with the asset device, storing identifying information associated with the asset device on a “blacklist” in the industrial network data repository system (e.g., MAC addresses, IP addresses, and/or any other metadata associated with the asset device), and/or otherwise ensuring the asset device can no longer communicate on the network 110. Once the one or more configuration parameters associated with the one or more asset devices have been modified, the method 1000 finally proceeds to step 1014 in which the process is ended.

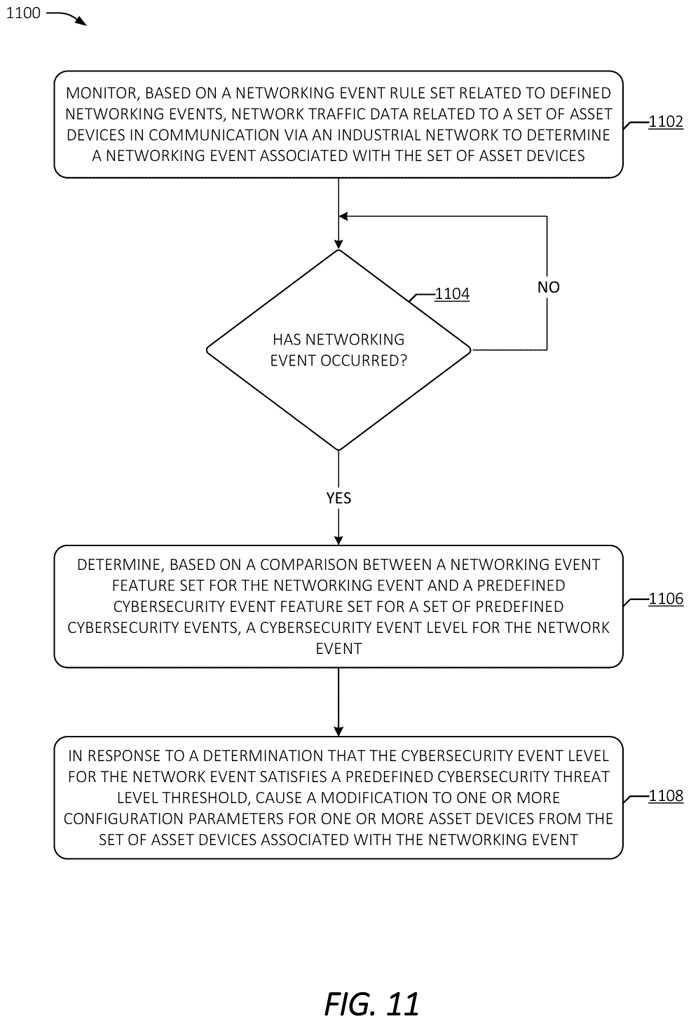

FIG. 11 illustrates a process flow diagram for analyzing historical log data to mitigate cybersecurity threats, in accordance with one or more embodiments described herein. Specifically, FIG. 11 illustrates a method 1100 for mitigating cybersecurity threats for an industrial network by determining whether a cybersecurity event has occurred on the industrial network based on the collected historical log data associated with the asset devices communicating on the industrial network. In one or more embodiments, the method 1100 is associated with the industrial network cybersecurity system 302. Additionally or alternatively, in various embodiments, the method 1100 is associated with the user computing device system 312 in conjunction with the industrial network cybersecurity system 302.

In one or more embodiments, the method 1100 begins at step 1102 in which the industrial network cybersecurity system 302 monitors, based on a networking event rule set related to defined networking events, network traffic data related to a set of asset devices in communication via an industrial network to determine a networking event associated with the set of asset devices. In one or more embodiments, the network traffic monitoring component 402 can generate networking events (e.g., networking events 714a-n). In one or more embodiments, each one of an identification of a new device, a detection of a modification in configuration parameters associated with one or more edge device(s) 161a-n, and/or a detection of suspicious activity by one or more devices on the network 110 can be compiled into a respective networking event (e.g., networking event(s) 714a-n) comprising a networking event feature set corresponding to any metadata related to the associated asset devices and any information related to the networking event itself. Data related to such networking events can be transmitted to a user computing device system 312 as part of the action data 308 and can be rendered, among other information, on an interactive user dashboard (e.g., interactive user dashboard 700) on the user computing device system 312 associated with the network 110. In various embodiments, networking events (e.g., networking event(s) 714a-n) comprise metadata related to a networking event type, an asset device identifier, an asset device address, a cybersecurity event level, a networking event description, networking event timestamp information, a networking event status, and/or a responsible administrator identifier. In one or more embodiments, the network traffic monitoring component 402 can, in conjunction with the data storage component 406, store and/or update the industrial network data repository system 314 with any data related to the network traffic data 304, data related to any of the one or more asset device instances associated with the devices communicating on the network 110, historical log data associated the asset devices communicating on the network 110, and/or any data related to the one or more networking events taking place on the network 110.

In various embodiments, types of networking events can be related to, but are not limited by, detected signal strength data associated with an asset device communicating on the network 110, a type of wireless protocol, a beacon event, a probing event, an authentication event, a data frame event, a network address sharing event, detected radio frequency signals collected from the airspace of the industrial environment associated with the industrial network, and/or another type of networking event. The types of networking events can additionally or alternatively be related to suspicious activity related to, but not limited by, unauthorized access where an unknown user is trying to access one or more asset devices, unusual activity performed by a user after gaining access to the one or more asset devices, anomalies in inbound and outbound industrial network traffic, detection of an untrusted device in the network, threats from internal users known as “insider threats,” as well as malicious activity related to know types of malware. In various embodiments, said types of suspicious activity can correspond to a predefined cybersecurity event feature set corresponding to a respective, predefined cybersecurity event of a set of predefined cybersecurity events stored in the industrial network data repository system 314.

The method 1100 also includes a step 1104, in which the industrial network cybersecurity system 302 determines whether a networking event has occurred on the network 110. In one or more embodiments, the industrial network cybersecurity system 302 repeatedly (e.g., continuously) monitors the network 110 to determine whether a networking event has occurred. If the industrial network cybersecurity system 302 determines that a networking event has occurred, the method 1100 proceeds to step 1106. If a networking event has not occurred, the method 1100 returns to step 1102.

The method 1100 also includes a step 1106 in which the industrial network cybersecurity system 302 determines, based on a comparison between a networking event feature set for the networking event and a predefined cybersecurity event feature set for a set of predefined cybersecurity events, a cybersecurity event level for the networking event. If the industrial network cybersecurity system 302 determines that the cybersecurity event level for the networking event satisfies a predefined cybersecurity threat level threshold, the industrial network cybersecurity system 302 can cause a modification to one or more configuration parameters for one or more asset devices from the set of asset devices associated with the networking event.

Cybersecurity event levels can include, but are not limited to, “critical,” “high,” “moderate,” and “informational.” Additionally, in some embodiments, networking events of varying severity can also be assigned to respective categories classifying the type of networking event. For instance, a rule pertaining to unusual activity being performed by edge device(s) 161a-n on the network 110 can be defined as a “security event” with a cybersecurity event level of “critical,” whereas a rule pertaining to an administrative change made to a group policy via the user computing device system 312 can be defined as a “Windows event” with a cybersecurity event level of “high.” Additionally and/or alternatively, in various embodiments, one or more of the plurality of rules comprised in the cybersecurity event component 404 of the industrial network cybersecurity system 302 can reflect international cybersecurity standards for industrial networks (e.g., ISA/IEC 62443) and respective cybersecurity event levels can be attributed to the networking event rules associated with the international standards. In one or more embodiments, the industrial network cybersecurity system 302 can compare a networking event that is currently taking place in real time to a set of predefined cybersecurity events. If, based on the comparison, the industrial network cybersecurity system 302 determines that the current networking event corresponds to a predefined cybersecurity event categorized as having a “high” cybersecurity event level, the industrial network cybersecurity system 302 can classify the networking event that is currently taking place as having a high cybersecurity event level.

The method 1100 also includes a step 1108 in which the industrial network cybersecurity system 302, in response to a determination that the cybersecurity event level for the networking event satisfies a predefined cybersecurity threat level threshold, causes a modification to one or more configuration parameters for one or more asset devices from the set of asset devices associated with the networking event. After classifying the cybersecurity event level of the networking event that is currently taking place, the industrial network cybersecurity system 302 can determine if the networking event satisfies a predefined cybersecurity threat level threshold defined by the cybersecurity event component 404. If the industrial network cybersecurity system 302 determines that the networking event satisfies the predefined cybersecurity threat level threshold, certain automatic actions can be executed. For example, in the event that a networking event associated with a high or critical cybersecurity event level occurs, the industrial network cybersecurity system 302 can trigger one or more alarms, determine an automatic cybersecurity threat mitigation action to execute on the network 110, and/or modify one or more configuration parameters associated with the one or more asset devices associated with the networking event. In one or more embodiments, the industrial network cybersecurity system 302 can also execute automatic cybersecurity threat mitigation actions to mitigate cybersecurity threats as the cybersecurity threats are detected. Such cybersecurity threat mitigation techniques can stop a cybersecurity threat quickly without the need for manual intervention, thus mitigating the cybersecurity threat and/or improving performance of an industrial network.

For example, if the industrial network cybersecurity system 302 detects a networking event with an associated cybersecurity threat level such as “critical” (such as unusual activity on the industrial network from an asset device with privileged user access permissions), the industrial network cybersecurity system 302 can temporarily decommission the associated asset device such that the associated asset device can make no further communications on the industrial network until the networking event can be reviewed. Likewise, if the industrial network cybersecurity system 302 detects a networking event with a cybersecurity event level classification of “high” (such as unauthorized insiders continually attempting to access part of the industrial network (e.g., the industrial network data repository system 314) from a particular asset device), the industrial network cybersecurity system 302 can automatically decommission the asset device, flag the user account in question, and/or transmit an alert to a user device with the details of the networking event.

In one or more embodiments, decommissioning an asset device can include at least one of, but is not limited to, de-powering or putting the device into a stand-by mode, modifying one or more configuration parameters associated with the asset device, changing user access permissions associated with the asset device, storing identifying information associated with the device on a “blacklist” in the industrial network data repository system (e.g., MAC addresses, IP addresses, and/or any other metadata associated with the asset device), and/or otherwise ensuring the asset device can no longer communicate on the industrial network.

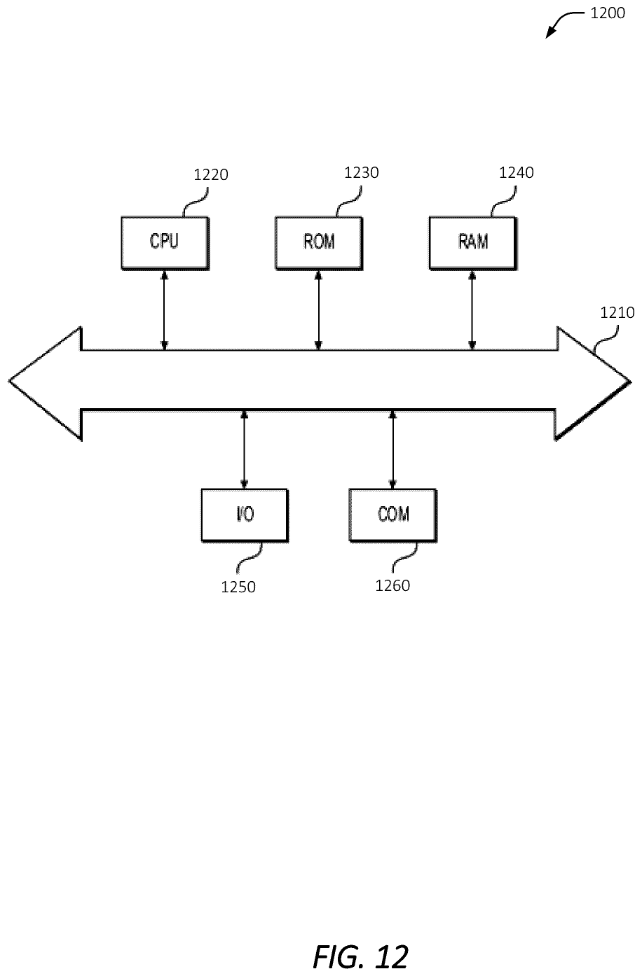

FIG. 12 depicts an example system 1200 that may execute techniques presented herein. FIG. 12 is a simplified functional block diagram of a computer that may be configured to execute techniques described herein, according to exemplary embodiments of the present disclosure. Specifically, the computer (or “platform” as it may not be a single physical computer infrastructure) may include a data communication interface 1260 for packet data communication. The platform also may include a central processing unit (“CPU”) 1220, in the form of one or more processors, for executing program instructions. The platform may include an internal communication bus 1210, and the platform also may include a program storage and/or a data storage for various data files to be processed and/or communicated by the platform such as ROM 1230 and RAM 1240, although the system 1200 may receive programming and data via network communications. The system 1200 also may include input and output ports 1250 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

In some example embodiments, certain ones of the operations herein can be modified or further amplified as described below. Moreover, in some embodiments additional optional operations can also be included. It should be appreciated that each of the modifications, optional additions or amplifications described herein can be included with the operations herein either alone or in combination with any others among the features described herein.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray Disc™ or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

What is claimed is:

1. A system, comprising:
one or more processors;
a memory; and
one or more programs stored in the memory, the one or more programs comprising instructions configured to:
monitor, based on a networking event rule set related to defined networking events, network traffic data related to a set of asset devices in communication via an industrial network to determine a networking event associated with the set of asset devices;
in response to the networking event:
determine, based on a comparison between a networking event feature set for the networking event and a predefined cybersecurity event feature set for a set of predefined cybersecurity events, a cybersecurity event level for the networking event; and
in response to a determination that the cybersecurity event level for the networking event satisfies a predefined cybersecurity threat level threshold, cause a modification to one or more configuration parameters for one or more asset devices from the set of asset devices associated with the networking event.

2. The system of claim 1, the one or more programs further comprising instructions configured to:
trigger an alarm associated with the networking event in response to the determination that the cybersecurity event level for the networking event satisfies the predefined cybersecurity threat level threshold.

3. The system of claim 1, wherein at least a portion of the network traffic data is related to radio frequency signals transmitted by the set of asset devices, and wherein the radio frequency signals are captured via a set of wireless sensors communicatively coupled to an edge gateway device.

4. The system of claim 1, wherein the defined networking events related to the networking event rule set are related to at least one of signal strength data associated with one or more asset devices of the set of asset devices, a type of wireless protocol employed by the one or more asset devices, an event associated with respective radio frequency signals transmitted by the one or more asset devices, a beacon event associated with the one or more asset devices, a probing event associated with the one or more asset devices, an authentication event associated with the one or more asset devices, a data frame event associated with the one or more asset devices and, a network address sharing event associated with the one or more asset devices.

5. The system of claim 1, the one or more programs further comprising instructions configured to:
determine the networking event based on at least one of a new asset device being added to the industrial network and a mapping of network switches in the industrial network.

6. The system of claim 1, the one or more programs further comprising instructions configured to:
compare a history log feature set associated with one or more asset devices of the set of asset devices to the predefined cybersecurity event feature set for the set of predefined cybersecurity events to determine the cybersecurity event level for the networking event.

7. The system of claim 1, the one or more programs further comprising instructions configured to:
render, on an interactive user dashboard of a user computing device, visualization data related to one or more networking events; and
generate, based on an interaction with the visualization data, a networking event report related to the one or more networking events.

8. The system of claim 1, wherein the instructions configured to determine the networking event associated with the set of asset devices further comprise instructions configured to:
identify the respective network protocol being used by one or more asset devices of the set of asset devices; and
classify the one or more asset devices as wireless devices or wired devices.

9. The system of claim 1, the one or more programs further comprising instructions configured to:
determine whether one or more asset devices of the set of asset devices communicating via the industrial network is a trusted device for the industrial network;
update metadata associated with a current status of the one or more asset devices, wherein the current status describes whether the one or more asset devices have been approved to communicate on the industrial network; and
in response to a determination that the one or more asset devices is a trusted device, updating baseline asset data associated with the industrial network to include metadata associated with the one or more asset devices.

10. The system of claim 1, wherein the networking event feature set comprises data associated with a networking event type, an asset device identifier, an asset device address, a cybersecurity event level, a networking event description, networking event timestamp data, a networking event status, and an administrator identifier.

11. A computer-implemented method, the computer-implemented method comprising:
monitoring, based on a networking event rule set related to defined networking events, network traffic data related to a set of asset devices in communication via an industrial network to determine a networking event associated with the set of asset devices;
in response to the networking event:
determining, based on a comparison between a networking event feature set for the networking event and a predefined cybersecurity event feature set for a set of predefined cybersecurity events, a cybersecurity event level for the networking event; and
in response to a determination that the cybersecurity event level for the networking event satisfies a predefined cybersecurity threat level threshold, causing a modification to one or more configuration parameters for one or more asset devices from the set of asset devices associated with the networking event.

12. The computer-implemented method of claim 11, the method further comprising:
triggering an alarm associated with the networking event in response to the determination that the cybersecurity event level for the networking event satisfies the predefined cybersecurity threat level threshold.

13. The computer-implemented method of claim 11, wherein at least a portion of the network traffic data is related to radio frequency signals transmitted by the set of asset devices, and wherein the radio frequency signals are captured via a set of wireless sensors communicatively coupled to an edge gateway device.

14. The computer-implemented method of claim 11, wherein the defined networking events related to the networking event rule set are related to at least one of signal strength data associated with one or more asset devices of the set of asset devices, a type of wireless protocol employed by the one or more asset devices, an event associated with respective radio frequency signals transmitted by the one or more asset devices, a beacon event associated with the one or more asset devices, a probing event associated with the one or more asset devices, an authentication event associated with the one or more asset devices a data frame event associated with the one or more asset devices, and a network address sharing event associated with the one or more asset devices.

15. The computer-implemented method of claim 11, the method further comprising:
determining the networking event based on at least one of a new asset device being added to the industrial network and a mapping of network switches in the industrial network.

16. The computer-implemented method of claim 11, the method further comprising:
comparing a history log feature set associated with one or more asset devices of the set of asset devices to the predefined cybersecurity event feature set for the set of predefined cybersecurity events to determine the cybersecurity event level for the networking event.

17. The computer-implemented method of claim 11, the method further comprising:
rendering, on an interactive user dashboard of a user computing device, visualization data related to one or more networking events; and
generating, based on an interaction with the visualization data, a networking event report related to the one or more networking events.

18. A computer program product comprising at least one computer-readable storage medium having program instructions embodied thereon, the program instructions executable by a processor to cause the processor to:
monitor, based on a networking event rule set related to defined networking events, network traffic data related to a set of asset devices in communication via an industrial network to determine a networking event associated with the set of asset devices;
in response to the networking event:
determine, based on a comparison between a networking event feature set for the networking event and a predefined cybersecurity event feature set for a set of predefined cybersecurity events, a cybersecurity event level for the networking event; and
in response to a determination that the cybersecurity event level for the networking event satisfies a predefined cybersecurity threat level threshold, cause a modification to one or more configuration parameters for one or more asset devices from the set of asset devices associated with the networking event.

19. The computer program product of claim 18, wherein at least a portion of the network traffic data is related to radio frequency signals transmitted by the set of asset devices, and wherein the radio frequency signals are captured via a set of wireless sensors communicatively coupled to an edge gateway device.

20. The computer program product of claim 18, wherein the defined networking events related to the networking event rule set are related to at least one of signal strength data associated with one or more asset devices of the set of asset devices, a type of wireless protocol employed by the one or more asset devices, an event associated with respective radio frequency signals transmitted by the one or more asset devices, a beacon event associated with the one or more asset devices, a probing event associated with the one or more asset devices, an authentication event associated with the one or more asset devices a data frame event associated with the one or more asset devices, and a network address sharing event associated with the one or more asset devices.
